(19) United States
(12) Patent Application Publication
(10) Pub. No.: US 2003/0028285 A1
(43) Pub. Date: Feb. 6, 2003

(54) Method and apparatus for fuel and fuel additive dispensing

(75) Inventors: Christopher P. Zura, Houston, TX (US); Robert Bennet Stout JR., Houston, TX (US); Jonathan Robert Guthrie, Houston, TX (US); Chris David Duhon, Houston, TX (US)

Correspondence Address: Hugh R. Kress, 2400 Bank One Center, 910 Travis Street, Houston, TX, 77002, US

(73) Assignee: ADDITECH, INC., HOUSTON, TX (US)

(21) Appl. No.: 10/036,656

(22) Filed: Dec. 21, 2001

Related U.S. Application Data
(63) Continuation-in-part of application No. 09/502,899, filed on Feb. 11, 2000.
(60) Provisional application No. 60/123,627, filed on Mar. 10, 1999.
(60) Provisional application No. 60/257,720, filed on Dec. 22, 2000.

(51) Int. Cl. G06F 17/00

(52) U.S. Cl. 700/241

(57) ABSTRACT

A method and apparatus for fuel and fuel additive dispensing is disclosed. In one embodiment of the invention, a programmable intermediary module is disposed in the path of communication of control and data signals between a fuel dispenser station and a point-of-sale (POS) controller subsystem. The intermediary module is programmable to intercept communications (control and data signals) transmitted between the dispenser and the POS controller, such that it can monitor, inject, intercept, filter, capture, convert, and/or modify communications between the fuel dispenser and and the POS controller. The intermediary module enables various enhanced control, monitoring, and reporting functions to be performed remotely and automatically. Further, the intermediary module enables various retail transactions to be integrated into a conventional fueling transaction without the necessity of extensive modification to an existing POS control subsystem. Additionally, the system supports a variety of interactive, real-time promotional and advertising operations to be conducted at the fueling station. In the disclosed embodiment, the intermediary module is coupled to and programmed and controlled by a control module which itself is coupled by a link to a central server. The server is preferably Internet-connected, and may additionally be functionally coupled to a local or wide-area network associated with the fuel retailer.

### RELATED APPLICATIONS

This is a continuation-in-part of prior pending U.S. patent application Ser. No. 09/502,899, filed on Feb. 11, 2000 and claiming the priority of provisional application Serial No. 60/123,627 filed on Mar. 10, 1999, the content of such applications being hereby incorporated by reference herein in there respective entireties. This application also claims the priority of provisional U.S. application Serial No. 60/257,720, filed on Dec. 22, 2000.

### FIELD OF THE INVENTION

The present invention relates generally to the dispensing of fuel additives, and more particularly to a system for adding fuel additives into a fuel refueling stream at a fuel dispenser.

### BACKGROUND OF THE INVENTION

The present invention relates to the addition of fuel additives into the fuel refueling stream at a fuel dispenser, simultaneous with a customer refueling his/her automobile in an otherwise normal manner.

Fuel additives are well known in the art. Such additives are typically petroleum-based or synthetic chemical products that can be formulated to address specific driving or automotive performance issues when added to gasoline or diesel fuels. Examples of the benefits of such additives include helping to clean fuel system components, enhancing overall engine performance, improving fuel economy, reducing emissions and preventing freezing of fuel lines in cold weather conditions.

Fuel additives are commonly blended into fuels at bulk loading terminals, for eventual retail sale through fuel dispensers as so-called “blended products.” Treat rates (i.e., the concentration levels) for such additives are low, as additization levels are primarily intended to enable the fuel to meet minimum EPA regulatory requirements. In response to the known benefits of fuel additives added to fuels in more concentrated levels, a market has developed over time for bottled after-market additives. Such additives can enable treat rates many times that of pre-blended additives, and, as a result, greatly enhance cleaning, performance and other benefits to consumers.

The purchase and use of bottled after-market additives can be an inconvenient, messy, and cumbersome process. Bottled additives must be purchased from a retail store and manually poured into the vehicle fuel tank prior to refueling. This process is often smelly and messy, as liquid can spill on the car or a consumer's clothing as the additives are being poured into the vehicle fuel tank. Customers must also decide the quantity of the bottle of additive required, based on the amount of fuel to be dispensed and recommended additive treat rates. Until they are properly discarded, partially-used additive containers are often left to roll around in the back seat or trunk of a vehicle, and can leak if bottles or cans are not properly secured. These aspects of the purchase and use of such additives are believed to have limited the market for such products. Various methods to facilitate the blending of fuel additives into fuels at fuel dispensers have been addressed in prior art. For example, U.S. Pat. No. 4,131,215 to Hansel and U.S. Pat. No. 5,163,586 to Zinsmeyer propose fuel dispensers with additive dispensing capabilities in which a fuel additive may be dispensed along with fuel, and the cost of the fuel plus additive combined to result in one blended price to the consumer. These technologies appear to be applicable only to newly manufactured fuel dispensers. In addition, such technologies would seem to require extensive redevelopment and upgrading of existing station fuel dispensers and point-of-sale systems to support the functionality required for fuel additive injection at fuel dispensers. As such, the aforementioned patents do not seem to address the need for technology for upgrading (i.e., retrofitting) existing fuel dispensers in the field.

U.S. Pat. No. 5,018,645 to Zinsmeyer proposes a fuel additive dispensing system separate from the fuel dispenser, in which additives are be blended into dispensed fuel, with the cost and amount of additive being displayed separately from that of the fuel. This technology involves a method for separating the fuel additive dispensing unit from the fuel dispenser. However, there remains a need in the art for technology that can be physically attached to any make or model of fuel dispenser, which can support full integration with existing station point-of-sale systems without the need for redevelopment or extensive upgrading of such point-of-sale systems, and which can support the multiple modes of customer selection, operation, and payment that is desirable for operating fuel additive dispensing systems.

Various technologies have also been shown in prior art for metering and blending of additives into fuels. For example, U.S. Pat. No. 4,253,436 to Dudrey proposes a system that includes a control unit for delivering a predetermined quantity ratio of additive to the amount of fuel pumped into a particular tank. U.S. Pat. No. 4,621,593 to Rao et al. proposes an apparatus for dispensing an additive into a fuel tank in dependence upon the level of fuel within a fuel tank. U.S. Pat. No. 5,251,785 to Hayden proposes a method of using electromagnetic energy transmitted through a window to blend additive into a flow stream at a controlled rate. U.S. Pat. No. 5,331,994 to Bryan proposes a system in which a minimum of three fuel level readings taken at fixed periods can be used to control the operation of an additive dispensing pump and maintain additive at a predetermined additive concentration with respect to the fuel. U.S. Pat. No. 5,441,072 to Indey, et al. proposes a method of dispensing additive at a variable rate corresponding to monitored variations in fuel flow rate. Finally, various technologies have been proposed for controlling the addition of an additive to the fuel while an engine is running through use of on-board additive tanks; U.S. Pat. No. 4,727,827 to Hoffman et al. and U.S. Pat. No. 5,195,466 to Schulte et al. are two examples of this.

In general, while each of these prior technologies addresses methods and processes that may support the injection of fuel additives at fuel dispensers, testing and evaluation of various metering methods indicates that there remains a need in the art for the development of metering technology suitable for the injection of fuel additives at fuel dispensers.

One need in particular relates to the interface between a fueling station and fuel additive dispensing equipment provided to enable the fueling station to dispense fuel additive in connection with a fueling operation, and to the integration of the control mechanisms and circuitry for a fuel dispenser with those of the fuel additive dispenser so as to provide for efficient point-of-sale transactions involving the dispensing of fuel, the dispensing of fuel additive, and other transactions.

### SUMMARY OF THE INVENTION

In view of the foregoing and other considerations, the present invention relates to a fuel additive dispensing system for a vehicle refueling station that enables customers at fuel dispensers to conveniently purchase and automatically blend supplemental fuel additives with their fuel during an otherwise normal refueling process. Further, the present invention enables a customer to pay for additives in the same form and manner as that of their fuel and/or other purchase items.

The disclosed invention includes several key components, including one or more additive storage tanks and flow lines, one or more fuel additive dispensing units that attach to existing (or new) fuel dispensers and provide fuel additive service to one or both sides of said fuel dispensers, electronic control and microprocessor components incorporated into each fuel additive dispensing unit that monitor customer actions and adjacent fuel dispenser conditions including grade of fuel selected and fuel flow volumes, hydraulic metering and injection equipment incorporated into each fuel additive dispensing unit that enable the injection of precise volume increments of fuel additives corresponding to successive, selectable volume increments of fuel, audiovisual display screens incorporated into each fuel additive dispensing unit that provide product and transactional information to customers through state-specific audiovisual sequences, and network computer control equipment that provides centralized control for fuel additive dispensing unit operational and transactional processes and enables fuel additive transactions to be integrated with corresponding fuel transactions for customer payment in the same form and manner as that of the fuel and/or other purchases.

For a field system installation, fuel additive dispensing units are attached to one or more fuel dispensers at a fueling station site. One dispensing unit can provide service to one or both sides (i.e. both fueling position locations) of a single fuel dispenser, and enable the choice of one or more types of additive products to customers. In accordance with one embodiment of the invention, a dispensing unit may be physically connected to the fuel dispenser through multiple physical, hydraulic, and electronic interconnections, through the use of various housings, flanges, and electronic cables that may vary based on the fuel dispenser make and model. Each dispensing unit at a site is also connected to two additional systems: one or more additive storage and pressuring systems that provide supplies of fuel additives to each dispensing unit, and a central network server that directs operational and transactional activities of all dispensing units located at a site. In accordance with another aspect of the invention, access to storage and pressuring means may variously be either internal or external to each dispensing unit, and the central network server may be either a stand-alone system or integrated within the body of the existing station point-of-sale system. The system design and manner of physical integration at a site enables existing fueling stations to be upgraded to include fuel additive dispensing capabilities without the need for extensive redevelopment, remanufacture, and reinstallation of the existing fuel dispensers or point-of-sale systems.

The primary interface between the invention and customers at fuel dispensers is through a graphic display integrated into the fuel additive dispensing unit. Such display is preferably located within the customer's normal field of vision with respect to the fuel dispenser, and can be canted toward the customer at an angle, to facilitate visibility and use. The display and accompanying electronic and computer control systems enable the dispensing unit to monitor operating and transactional information on the invention and the adjacent fuel dispensing equipment on a real-time basis, including grade of fuel selected and fuel flow volume. Further, the display and electronic systems are preferably capable of simultaneously displaying multiple types of text, graphics, and transactional information in different areas of the display screen.

A display system associated with the dispensing in accordance with the present invention can preferably display running totals for the purchase of fuel additives by itself or simultaneous with the display of other information, and provide interactive, state-specific, graphical and/or textual display information to customers, such that each of any number of additive dispensing systems at a site can display separate display content for each customer, thereby responding to specific modes of customer activity or equipment conditions at either the additive dispenser or the adjacent fuel dispenser. Preferably, the display and associated electronic system can send and receive transactional information required to support customer payment in the same form and manner as for the fuel or other purchases. In one embodiment, the video display may include an audio speaker to support the presentation to customers, and a proximity detector that can sense the presence of a customer or automobile so that video and/or audio content can be initiated or changed as a customer approaches the fuel dispenser.

Each fuel additive dispensing unit located at a site can interconnect either at the fuel dispenser with electronic circuitry that enables additive transactions to be integrated with the fuel transactions through the existing retail point-of-sale system, or via network computer communication (traditional cable or RF, for example) to a separate, stand-alone computer network server which functions as a central network control hub separate from the station retail point-of-sale system. Interactions between a central network server and each dispensing unit support the various transaction authorization, control, processing, data storage, and video display functions that are necessary for invention operation. In addition, the central network server also interfaces with the existing retail station point-of-sale system to enable fuel additive transactions to be matched with the corresponding fuel transactions and facilitate payment of the additives in the same form and manner as for the fuel or other purchases.

In accordance with one aspect of the invention, consumer use of the system is quick, easy, and convenient. Consumers view product related information on the display screen included in the dispensing unit before and during the normal refueling process. This feature provides an optimum means of educating and informing a customer regarding the features and benefits of the additive products offered, as well as how to make and pay for a selection. If a customer does not wish to purchase an additive, the refueling transaction proceeds as normal. If, however, a customer does desire an additive, the system enables the customer to select among one or more types of additives, and, notably, to make a selection at any point during the refueling process. The customer merely presses a button located on the dispensing unit (typically on or near the display screen) to make a product selection. The invention also supports the ability of consumers to make an additive selection inside the fueling station or at a kiosk if it is desired to prepay for fuel and additive prior to the fuel transaction. Finally, in alternate embodiments product information and product selections may be made on the fuel dispenser, through electronic communications with the dispensing unit and the central network server.

Once a selection is made, computer-controlled electronic and hydraulic systems monitor fuel dispenser activity on a real-time basis, such that precise volume increments of the selected additive may be injected directly into the fuel refueling stream, commensurate with successive volume increments of fuel dispensed. Additive increments can be varied through configurable software logic adjustments, made either at compile time or through the provision of software options. In addition, dispensing can proceed in one of three modes of injection: In one embodiment, all dispensed fuel is treated with additive without regard to when an additive selection is made. Alternatively, only fuel dispensed subsequent to when an additive selection is made may treated with additive. As another alternative, a preset volume of additive may be injected regardless of the volume of fuel dispensed. Following a transaction, each dispensing unit transfers additive sales data through the central network server to the station point-of-sale system so as to enable customers to pay for the additive purchased in the same form and manner as that of their fuel or other purchases: either at the fuel dispenser (via payment system integrated into the dispenser) or inside the store or at the kiosk. In the case of prepaid transactions, such transfer of post-transaction additive sale data may be preceded by the transfer of additive authorization data prior to the sale.

In accordance with another aspect of the invention, an electronic intermediary module is established between a point-of-sale fueling station and fuel additive dispensing equipment. In one embodiment, the intermediary module comprises a combination of hardware and software that is placed in-line between a fueling station (commonly referred to as a “fuel pump” or a “fuel dispenser”) and a point-of-sale (“POS”) system. The intermediary module allows a display and control module coupled thereto to monitor, inject, intercept, filter, convert, capture, and modify communications between the pump and the POS system.

The present invention advantageously enables fuel retailers and/or automotive consumers to select and add fuel additives into the fuel refueling stream at the fuel dispenser while an automobile is being refueled in the normal manner. Further, the present invention advantageously enables the cost of such additives to be integrated with the corresponding fuel transactions so as to enable customers to pay for the additive purchased in the same form and manner as that of their fuel or other purchases. Moreover, in accordance with a further aspect of the invention, existing stations may be upgraded (i.e., retrofitted) to include additive dispensing capabilities and other point-of-sale and transactional capabilities in accordance with the principles of the present invention without the need for extensive reengineering, remanufacture, and reinstallation of the existing fuel dispensers or point-of-sale systems.

### BRIEF DESCRIPTION OF THE DRAWINGS

The foregoing and other features and aspects of the subject invention will be best understood with reference to a detailed description of a specific embodiment of the invention, which follows, when read in conjunction with the accompanying drawings, in which:

FIG. 1 is an exploded view of a conventional fuel dispenser and a fuel additive dispensing unit in accordance with one embodiment of the invention;

FIG. 2 is a partially cut-away view of the fuel additive dispensing unit from FIG. 1;

FIG. 3. is a partially cut-away view of a fuel additive dispensing unit in accordance with an alternative embodiment of the invention;

FIG. 4 is an illustration of a display and control module from the fuel dispensing unit of either the embodiment of FIG. 1 or the embodiment of FIG. 2;

FIG. 5 is a state diagram representing operational states and events occurring in a fuel and fuel additive dispensing system in accordance with one embodiment of the invention;

FIG. 6 is a state diagram representing operational states and events occurring in a fuel and fuel additive dispensing system in accordance with an alternative embodiment of the invention;

FIG. 7 is a block diagram of a fueling station showing the general manner in which each invention unit can be connected to a central network computer server, and a schematic of the primary communication linkages between a typical fuel dispenser, the invention, the central network server, and the station point-of-sale system;

FIG. 8 is a functional block diagram of a fuel and additive dispensing system in accordance with one embodiment of the invention;

### DETAILED DESCRIPTION OF SPECIFIC EMBODIMENTS OF THE INVENTION

The present invention makes use of and integrates two principal technologies: fuel dispensing systems and computer-based electronic control systems. In the disclosure that follows, in the interest of clarity, not all features of actual implementations are described. It will of course be appreciated that in the development of any such actual implementation, as in any such project, numerous engineering and programming decisions must be made to achieve the developers' specific goals and subgoals (e.g., compliance with system- and business-related constraints), which will vary from one implementation to another. Moreover, attention will necessarily be paid to proper engineering and programming practices for the environment in question. It will be appreciated that such a development effort might be complex and time-consuming, but would nevertheless be a routine undertaking for those of ordinary skill in the fields of computer and control system design and fuel dispensing technology having the benefit of this disclosure.

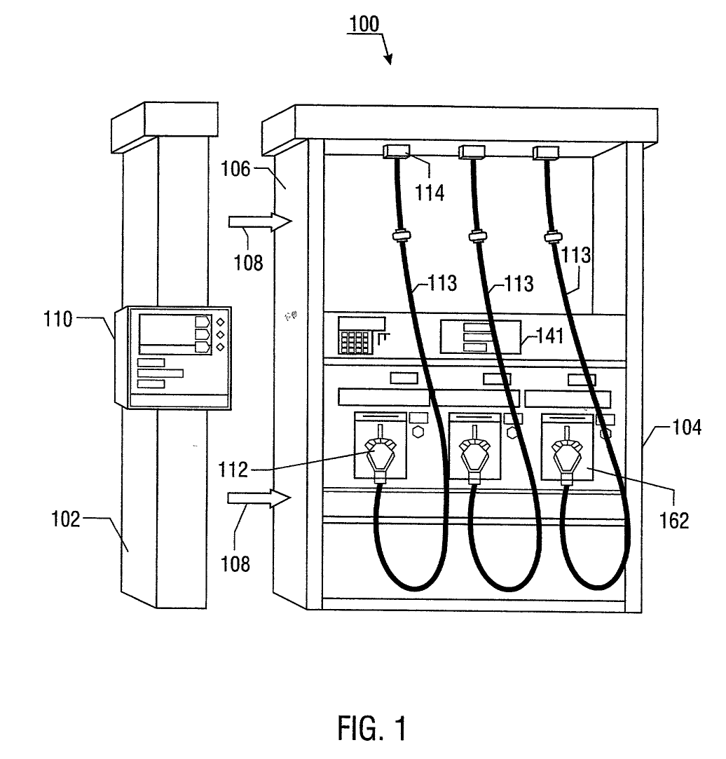

Referring to FIG. 1, there is shown a fuel dispensing system 100 incorporating a fuel additive dispensing unit 102 in accordance with one embodiment of the invention. It is to be understood that FIG. 1 is a partially exploded view, in that it shows the general manner in which the disclosed embodiment of a fuel additive dispensing unit 102 is attached to the side of a fuel dispenser 104 (sometimes referred to in common parlance as a “gas pump”) by removing existing fuel dispenser side panel 106 and bolting or otherwise affixing dispensing unit 102 onto the side of fuel dispenser 104 at the prior location of the dispenser side panel 106. The installation process is reflected by arrows 108 in FIG. 1 indicating how additive dispensing unit 102 is directed toward fuel dispenser 104 during an installation procedure. In the disclosed embodiment, the rigid (e.g. steel) external housing of dispensing unit 102 is sized and shaped so as to complement the configuration of the side of fuel dispenser 104, making the mating of dispensing unit 102 with fuel dispenser natural and aesthetically inconspicuous. Further, fuel dispenser side panel 106 may be reattached to the exterior side of dispensing unit 102, so as to preserve existing color schemes, brand name logos, and the like.

In the presently preferred embodiment of the invention, fuel dispensing unit 102 is adapted to be attached to the side of fuel dispenser 104, although it is to be understood that other configurations may be adopted, and that in alternative embodiments, dispensing unit 102 may be configured to be attachable at locations on dispenser 104 other than the side thereof. In one embodiment, dispensing unit 102 comprises a rigid (e.g., steel) housing.

Several additional connections are made between dispensing unit 102 and fuel dispenser 104 to complete the physical installation. First, electronic cable(s) (not shown in FIG. 1) from dispensing unit 102 are connected to cables emanating from each of the fuel flow meters and nozzle lift indicators inside fuel dispenser 104. Such connections enable electronic and computer circuitry inside dispensing unit 102 to monitor fuel flow rates on a real-time basis through monitoring of pulses or other outputs of the fuel flow meters, as displayed on fuel dispenser 104 on a display designated with reference numeral 141 in FIG. 1. In addition, such connections also enable the electronic and computer circuitry of dispensing unit 102 to monitor the grade of fuel selected by the customer and the initiation and termination of fueling transactions on a real-time basis, as such events are conducted by a customer at a nozzle location 112 or other location.

Regarding display 140, it is contemplated that numerous known display technologies, including without limitation, liquid crystal display (LCD) screens, video display screens, and the like, will be suitable for the purposes of practicing the present invention. It is believed that those of ordinary skill in the art having the benefit of the present disclosure will be readily able to implement a suitable display 140 for the purposes of the invention as described herein.

In the disclosed embodiment, such electronic cable(s) use multiple pin connectors in which the electronic cable(s) from dispensing unit 102 tie in to cable(s) inside fuel dispenser 104 emanating from each of the fuel flow meters and nozzle lift indicators. Such cables(s) are of various types, as necessary to fit each of various makes and models of fuel dispensers 104. All such cable(s) are integrated into fuel dispenser 104 in a manner so as not to interfere or alter normal fuel dispenser operation. In an alternate embodiment, such interconnections of dispensing unit 102 with the fuel flow meters and nozzle lift indicators inside fuel dispenser 104 are accomplished via linkage to an interface box or other system that separately monitors and enables access to data and information regarding fuel dispenser activities and operating conditions.

Second, electronic cables from dispensing unit 102 connect to an electrical junction box (not shown in FIG. 1) inside fuel dispenser 104 in a manner to enable dispensing unit 102 to receive electrical power from fuel dispenser 104.

Finally, fuel additive product flow lines emanating from dispensing unit 102 connect to each of the fuel flow lines inside the dispenser 104 at a convenient point such as that designated generally with reference numeral 114 in FIG. 1, downstream of each fuel flow meter. In this way, fuel additives can be injected into the fuel refueling stream at fuel dispenser 104 downstream of each fuel flow meter. At such point of interconnection 114, check valves and/or other flow control means are used to prevent reverse flow of fuel or additive through fuel dispenser 104 or the fuel additive flow lines inside dispensing unit 102. With regard to the check valves, in the presently preferred embodiment, a model 2232T1-2MM check valve commercially available from Circle Seal Controls, Inc., Corona, Calif. is believed to have the desired combination of internal components, pressure rating, and durability for the purposes of the present invention.

Those of ordinary skill in the art will appreciate that the means of such interconnection 114 may be via custom-designed flanges, injection ports, or other suitable means, depending on requirements for each various make and model fuel dispenser 104. It is believed that the exact nature of the interconnection is not critical for the purposes of the present disclosure, beyond what has been stated above.

In various alternate embodiments, connections of fuel additive flow lines from dispensing unit 102 to fuel flow lines inside fuel dispenser 104 may be made at a point upstream of the fuel flow meters. In addition, dispensing unit 102 may alternatively be configured and attached to fuel dispenser 104 in a variety of manners and at various locations. It is believed that those of ordinary skill in the art having the benefit of the present disclosure will recognize and appreciate these and many other such design options and alternatives which may differ from implementation to implementation.

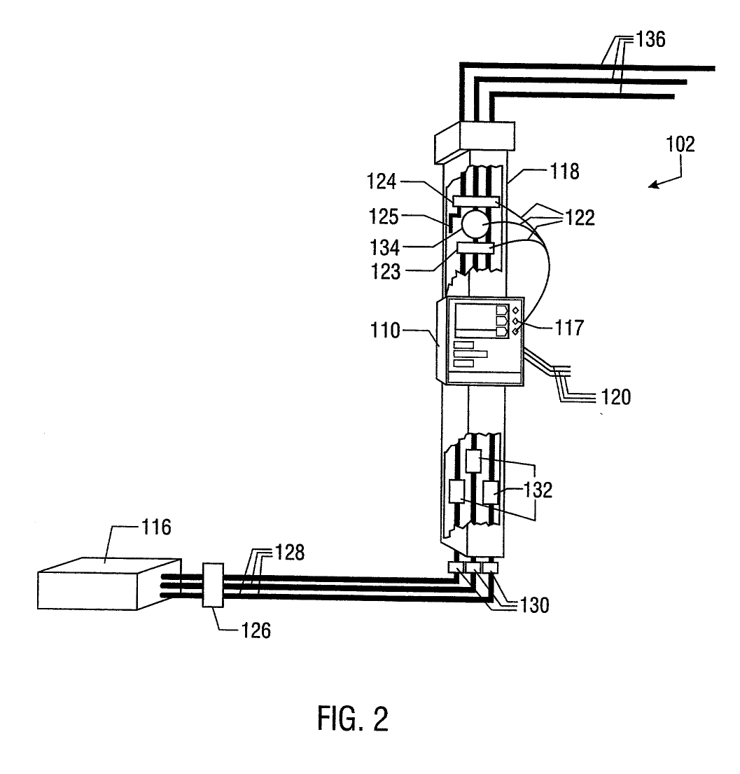

Turning now to FIG. 2, there is shown a partially cut-away view of dispensing unit 102 in accordance with the presently disclosed embodiment of the invention. In the embodiment of FIG. 2, a fuel additive storage and pressuring unit 116 is located exterior to the body of dispensing unit 102. In this embodiment, a customer at fuel dispenser 104 would view display content on a display and control module 110 associated with dispensing unit 102, and make a selection at any point during the fueling transaction, for example by pressing a selection button such as button 117 in FIG. 2 adjacent to or on display and control module 110. After a selection is made by the customer, electronic and computer circuitry integrated into the display and control module 110 of the invention senses such selection.

In the presently disclosed embodiment, display and control module 110 comprises electronic circuitry for controlling the display content of display 140, and further comprises circuitry and user interface means (e.g., buttons, touch-sensitive displays, and the like) for enabling a customer to select one or more options associated with the dispensation of fuel additives. It is believed that those of ordinary skill in the art having the benefit of the present disclosure would be readily able to implement the electronics associated with display and control module 110 to achieve the functionality described herein; accordingly, the specific implementation details for display and control module 110 are described herein primarily in functional terms.

As will be hereinafter described in further detail, in accordance with one aspect of the invention display and control module 110 may be responsive to user interaction either before or during a fueling operation to initiate the dispensation of fuel additive into the stream of fuel dispensed from dispenser 104. This is believed to be a particularly advantageous aspect of the invention, since it enables to customer to initiate the dispensation of fuel additive even after a fueling process has begun.

A hydraulic module for controlling the flow of additive that is dispensed is designated generally with reference numeral 118 in FIG. 2. After an additive selection is made by a customer, or indicated based on other criteria, fuel dispenser conditions are monitored through electronic cables designated with reference numeral 120, and electronic signals are sent through electronic cables 122 to direct the operation of input manifold(s) 123 and output manifold(s) 124 that are disposed within hydraulic module 118. Such operation causes the selected fuel additive product to flow from the additive storage means 116 by way of the pressure generated by a pump 126 into dispensing unit 102 through additive flow lines 128, safety breaks 130, and filtration means 132, into and through an additive flow meter 134 integrated into hydraulic module 118, and then into the appropriate additive flow line 136. This in turn causes the selected fuel additive to be injected into the appropriate fuel flow line inside fuel dispenser 104. In one embodiment, pump 126 may be selectively turned on and off by electronic signals generated by display and control module 110.

Hydraulic module 118 in the presently disclosed embodiment provides fuel additive service to one or both sides of fuel dispenser 104 (i.e. both fueling positions), and in one embodiment is comprised of one or more sets of inlet flow control manifolds 123 and outlet flow control manifolds 124, upstream and downstream, respectively of a positive displacement flow meter 134. Each inlet manifold 123 incorporates one solenoid valve for each additive product. Each outlet manifold 124 incorporates one solenoid valve for each gasoline hose 113 plus one solenoid valve that allows flow to be redirected through a calibration testing line 125 for the purposes of volume accuracy testing. (As used herein, the term gasoline hose 113 will be used to refer to the familiar, typically flexible rubber hose having a nozzle at its distal end for manual insertion into the fuel tank of a customer's automobile. On the other hand, it is intended that the term “hose” as used herein shall be interpreted broadly to encompass any means by which gasoline is dispensed from dispenser 104 into an automobile's gas tank, including all presently known such means and any means to be developed in the future.)

The terminus end of calibration testing line 125 includes a check valve (not shown) and a valve (also not shown) for control of flow testing and subsequent sealing by weights and measures officials. In the presently preferred embodiment, the check valve on calibration testing line 125 is a model SS-CHM4-10 valve commercially available from Swagelok Inc. The SS-CHM4-10 has been found to maintain a positive seal after closure, advantageously leaving consistent volumes of additive in the calibration line. This is believed to be desirable for maintaining consistent volume accuracy readings for weights and measures testing.

In operating mode, an upstream solenoid valve on an inlet manifold 123 is actuated corresponding to an additive selected by a customer, and a downstream solenoid valve on an outlet manifold 124 is actuated corresponding to the grade of fuel selected by the customer.

In calibration mode, an upstream solenoid valve on an inlet manifold 123 corresponding to an additive selected by an operator or testing official is actuated. A downstream solenoid valve on an outlet manifold 124 is actuated such that additive flow is redirected through calibration testing line 125.

Those of ordinary skill in the art will appreciate that in alternate embodiments, various combinations of manifolds, solenoid valves, flow meters, or calibration lines could be used to provide service to one or both sides of the fuel dispenser. Additionally, although the present disclosure speaks in terms of one or more discrete hydraulic “modules” 118, this is done solely for the purposes of ease of collective reference. It is to be understood that the various hydraulic elements (manifolds, solenoids, flow control meters and the like) comprising hydraulic modules 118 may not be implemented in the form of discrete units physically segregated from other components of the overall system, but instead may be physically distributed and located in different positions with respect to dispensing unit 102 and dispenser 104, as implementation requirements dictate. It is intended that the term “hydraulic module” as used herein shall encompass any arrangement of the various hydraulic control elements necessary for performing the flow control functions described herein.

In the presently disclosed embodiment, manifolds 123 and 124 are conventional off-the-shelf components such as the No. 82626G208 solenoid valve commercially available from Automatic Switch Company (ASCO), Florham Park, N.J. (http://www.ascovalve.com). ASCO uses the designations HP 274387, HP 274388, and HP 274401 to refer to configurations of 8262G208 valves and manifolds presently preferred for the purposes of practicing the present invention.

Flow meter 134 may be the Series 210 Positive Displacement Flow Meter commercially available from Max Machinery, Inc., Healdsburg, Calif. (http://www.maxmachinery.com). Specifically, the presently preferred flow meter for the purposes of practicing the present invention is the Max Machinery model 214-410-000 flow meter with V884 material, in association with a Max Machinery model 284-522-000 sensor and electronics assembly for monitoring flow meter activity and emitting electronic pulses commensurate with metered volumes.

Those of ordinary skill in the art having the benefit of the present disclosure will appreciate, however, that various forms and combinations of components such as described herein can be employed in additional embodiments, such as different configurations for additive storage and pressuring means, different numbers of additive flow lines and corresponding downstream or upstream components corresponding to multiple options of additive products offered to customers, different manifold and flow meter configurations, and the use of various numbers, types, and combinations of pumps and flow meters inside or outside dispensing unit 102 to transport and accurately measure fluid volumes within the appropriate tolerances.

In operation, electronic and computer control circuitry and injection control software inside display and control module 110 enable the monitoring of customer activity and operating conditions at the fuel dispenser on a real-time basis through electronic cables 120, such that the information such as the gasoline grade selected, the initiation and termination of fuel flow, and actual fuel flow volume may monitored. For example, in one embodiment, fuel flow is monitored through the counting of electrical pulses recorded by the fuel flow meter, the number of pulses being proportional to fuel volume.

As noted above, it is believed that the specific implementation of the electronic circuitry needed to implement the functions and functionality described herein, particularly that of display and control module 110 are not critical for the purposes of the present invention, and that the design and implementation of such electronics would be a matter of routine engineering to a person of ordinary skill in the art. Accordingly, specific implementation details about the electronics in the disclosed embodiment shall not be further described herein.

As quantities of dispensed fuel are monitored, electronic signals from the electronic and computer control circuitry inside display and control module 110 through electronic cables 122 cause the appropriate combination of solenoid valves to sequentially open and close to permit volume increments of the selected additive to be transported through positive displacement flow meters. In the disclosed embodiment, such flow meter outputs a stream of electrical pulses, in which the number of pulses is proportional to fluid volume. Since the timing sequences for the opening and closing of solenoid valves can be affected by operating temperature, fluid pressure, flow rate, valve wear, solenoid type (e.g., AC or DC), and other factors, all of which can impact metered volume, dispensing unit 102 maintains a real-time log of valve timing, cumulative additive volume injected since a predetermined starting point and target cumulative volume injected. This data is processed by computer-controlled algorithms to enable automatic sensing, correction, and ensuing adjustment of subsequent valve timing and injected volumes to optimize metering accuracy. In one embodiment, adjustment of valve timing and injected volumes can be based upon assessment of past performance of the metering system and current hydraulic conditions as detected by the various sensors in the hydraulic module. This is referred to as an “adaptive metering” functionality.

In one embodiment, such computer monitoring and control preferably achieves metering accuracy to within approximately 0.75% tolerance levels, despite the relatively low volume of additive being dispensed. That is, in the presently preferred embodiment, hydraulic module 118 is preferably capable of ensuring that the amount of additive actually injected into a fuel flow line is within 0.75% of the amount of additive selected and intended to be injected. Those of ordinary skill in the art will appreciate that such accuracy is particularly desirable given the relatively small amounts of additive that are typically dispensed during any given fueling operation. After each additive volume increment is metered, it is subsequently injected into the fuel stream through additive flow lines 136 into the fuel refueling stream at fuel dispenser 104.

Additive volume increments are preset quantities that are dispensed so as to correspond to successive predetermined volume increments of fuel dispensed. Through means of configurable injection control software and other electronic and computer control circuitry inside display and control module 110, dispensing unit 102 has the capability to inject additive in varying volume increments at any point during the fueling process, such as at the initiation of fuel dispensing or at any point during any monitored volume increment of fuel dispensed. For example, in one embodiment, dispensing unit 102 injects additive in predetermined volume increments (for example, 0.8 ounces at a time) at, for example, the beginning or the midpoint of each gallon volume increment of fuel dispensed. In alternative embodiments, a predetermined increment of additive may be injected at the beginning of each gallon of fuel dispensed, or at the end of each gallon of fuel dispensed, or at the beginning, end, or any other point during any desired increment of fuel. In still another contemplated embodiment, a single, predetermined amount of additive, as opposed to multiple incremental amounts of additive, is injected; this can be likened to a customer purchasing a bottle of additive, for example, twelve ounces, and manually pouring it into a vehicle's gas tank.

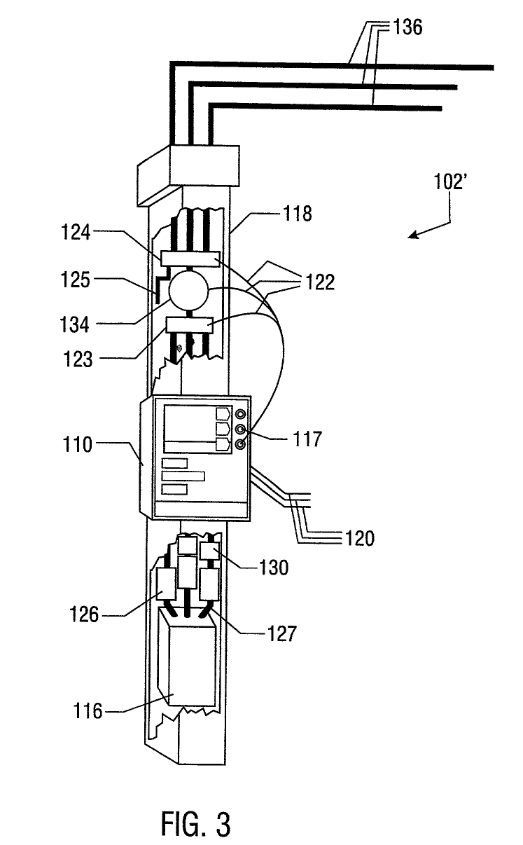

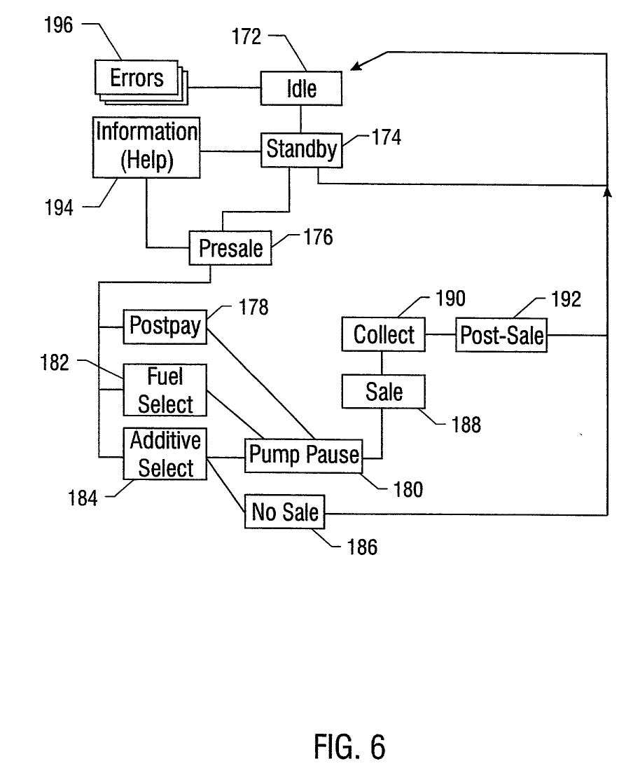

FIG. 3 is a partially cut-away view of an alternative embodiment of an additive dispensing unit 102′ in which the fuel additive storage and pressuring means 116 is included within the body dispensing unit 102′, rather than externally as in the embodiment of FIG. 2. (It is to be understood that those elements in the embodiment of FIG. 3 which are essentially identical to corresponding elements in the embodiment of FIG. 2 have the same reference numerals in both of those Figures.) With the embodiment of FIG. 3, customers at fuel dispenser 104 view display content on the display screen 140 associated with display and control unit 110, and make selections at any point during the fueling transaction by pressing a selection button 117 adjacent to or on the display and control module 110. After a selection is made by the customer, or indicated by other means (such as a preset additive condition on a prepaid additive sale) the electronic and computer circuitry integrated into the display and control module 110 senses such selection, and monitors fuel dispenser conditions through electronic cables 120 and directs the operation of manifolds 124 and valves in hydraulic module 118 through electronic cables 122 such that the selected fuel additive product flows from the additive storage means 116 by way of the pressure generated by pump 126 through additive flow lines 127, and filtration means 130, into and through an additive flow meter 134 integrated into the hydraulic module 118, and then into the appropriate additive flow line 136 which in turn causes the selected fuel additive to be injected into the appropriate fuel flow line inside the fuel dispenser. In one embodiment, pump 126 can be selectively turned on and off by electronic signals generated by control and display module 110 in response to a customer selection of an additive or other event indicating an additive selection made or status of a transaction. Alternatively, pump 126 may be controlled from elsewhere, as will hereinafter be described with reference to FIG. 6.

The further description of the physical and operating characteristics of the embodiment disclosed in FIG. 2 is identical to that of the embodiment disclosed in FIG. 3. In addition, as with the potential variability or location of the components in FIG. 2, additional embodiments could make use of alternate equipment configurations, including various types and combinations of the pump 126 and filtration means 130 located either under, adjacent to, on, or inside the additive storage means and other various combinations, location, or types of other components as noted for the embodiment disclosed in FIG. 2. In addition, the components, mechanism, form and manner of the use and operation of the hydraulic module 118 and the variety of methods of additive injection and all other comments relative to the hydraulic module 118 would be similar to such comments made relative to the hydraulic module 118 in connection with the description of the embodiment of FIG. 2.

In the self-contained embodiment depicted in FIG. 3, a suction pressure fill cap is employed to seal fuel additive and pressure means 116. In the presently preferred embodiment, this cap (not depicted in the Figures) is a model 60002 suction pressure fill cap commercially available from Central Illinois Manufacturing Company, Bement, Ill.

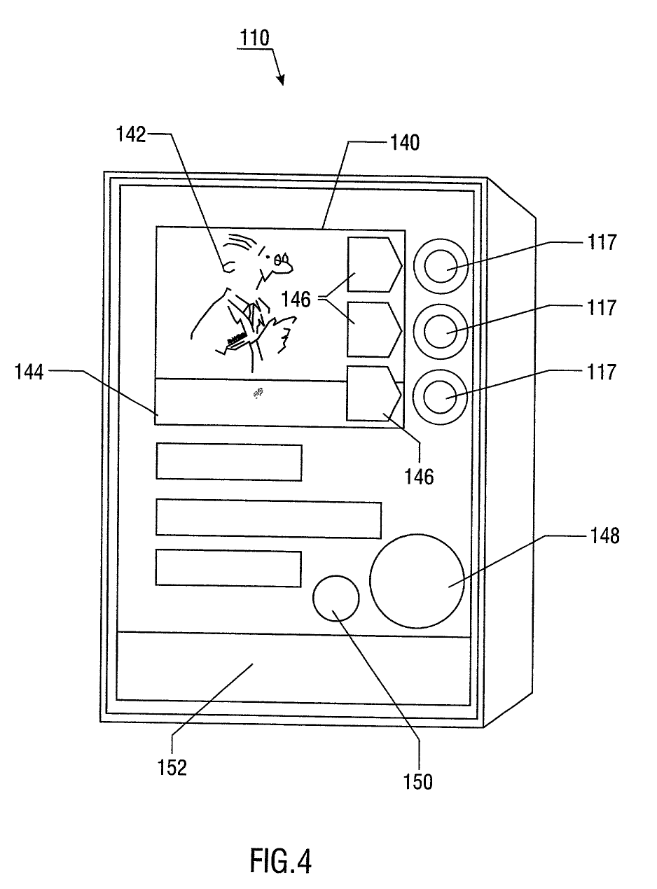

FIG. 4 depicts display and control module 110 in accordance with one embodiment of the invention. (Those of ordinary skill in the art will appreciate that display and control module 110 is essentially the same in the embodiments of FIGS. 2 and 3, respectively; hence for the purposes of the following disclosure, references to dispensing unit 102 shall be interpreted as applicable to either embodiment, unless otherwise noted.) In the presently disclosed embodiment, display and control module 110 is essentially integral with the housing of dispensing unit 102, although those of ordinary skill in the art will appreciate that display and control module may be affixed to the housing of dispensing unit 102 or fuel dispenser 104 from the housing of dispensing unit 102 or fuel dispenser 104 and connected to the internal components of dispensing unit 102 via multiple cables or wires.

As noted above, display and control module 110 preferably houses key electronic and computer components and the display screen for presenting graphical and textual information to customers. Display and control module 110 includes multiple types of electronic and computer circuitry inside a display housing which may integrated into dispensing unit 102.

In one embodiment, display and control module 110 includes a display screen 140 that is segregated into different, specific viewing areas. In the example of FIG. 4, display screen 140 is segregated into three distinct viewing areas designated with reference numerals 142, 144, and 146. Each viewing area 142, 144, and 146 is assigned a given function and is under the coordinating control of a specific, independent software code set that works in tandem with the electronic and computer circuitry in the display and control module 110 to enable each screen area to display different types/formats of text or graphical content independent from content that may be displayed on the other areas of the screen 140. In the presently preferred embodiment of the invention, display and control module 110 incorporates a computer platform that is essentially a conventional personal computer class of computer. For example, display and control module 110 may comprise a computer based on the well-known Intel™ Pentium™ class of central processing unit or the like, having conventional sub-components such as memory, graphics circuitry and the like associated therewith. Those of ordinary skill in the art will appreciate, of course, that certain functions of dispensing unit 102, including those of display and control module 110, may be performed by dedicated subsystems having their own processing capabilities. Such implementation-specific considerations are not believed to be particularly critical for the purposes of appreciating the present invention. It is believed that those of ordinary skill in the art having the benefit of the present disclosure would be readily able to implement a display and control module suitable for the purposes of practicing the present invention as a matter of routine engineering.

In the disclosed embodiment, an upper left portion of the screen 142 is used to display various types of video text, graphics, advertising, promotional and/or infomercial content related to the use and operation of the system, as well as fuel additive product choices, features, and benefits. Such screen area 142 is controlled by an independent software code set and time function in which one or more video and/or audio files stored on RAM within the electronic and computer circuitry of the display and control module 110 are accessed through configurable controls and directed to be displayed on screen area 142 during a specific state for either a specific time duration or until a specific event happens. For example, such specific event may be a customer action that triggers a change to a different state. Through the use of the independent software code set and time function, the display of such video and/or audio files on screen area 142 for any state can be controlled independent of each other and independent of content that may be displayed simultaneously on other screen areas.

A bottom portion of the screen 144 is used to display static or running totals of dispensed additive volume, updated on a real-time basis for volume and sale totals for dispensed fuel additive products. Such screen area 144 is controlled by an independent software code and is event-driven on a basis independent of the other screen areas. During an additive dispensing process, dispensed volume data is monitored and/or calculated for each increment of additive dispensed, and the screen area 144 is updated on a real-time basis as such information is received.

A right side of the screen 146 is used to display fuel additive product names and prices which correspond to context-sensitive selection buttons 117 located either on or adjacent to the screen 140. Such screen area 146 is controlled by an independent software code set which enables the display to be changed/updated based on one of three specific events. First, at the end of every sale, prices and product names can be read by the electronic and computer circuitry within the display and control module 110 from configuration files in the central network server. The right portion of the screen is changed to reflect any such price or product name change that has occurred. Second, during an additive sale, the prices and/or product names of the “non-selected” additives are blanked-off, or erased from customer's view. This enables the customer to only see information corresponding to the selected product after a selection has been made. Third, the electronic and computer circuitry within the display and control module 110 may receive a specific message from the central network server instructing it to reread price or product name information. If so, it rereads and updates such information, unless if such message is received while an additive transaction is in progress, it waits until the sale is completed to read and update such information. Through the use of such independent software code sets within the electronic circuitry of display and control module 110, each area of the screen can display different types/formats of text and graphical content either simultaneous with or independently from that displayed on the other areas of the screen 140, regardless of the content displayed in the other areas.

Display and control module 110 in the presently disclosed embodiment may further include additional components for facilitating consumer use of dispensing unit. An audio speaker 148 may be integrated into display and control module 110 to support the use of audio in conjunction the graphical content displayed on screen 140. A proximity detector 150 may also be integrated into the display and control module 150. Proximity detector 150 may advantageously be used to detect the presence of an approaching customer or automobile such that audiovisual content can be changed or initiated specifically for each customer, as the customer approaches a dispensing unit 102 or fuel dispenser 104 at the site. Proximity detector 150 may be, for example, an infrared motion sensor or the like, such as is commonly employed for the purposes of detecting a person's presence in a particular area. In one embodiment, proximity detector 150 is responsive to the detection of a person in the vicinity of dispensing unit 102 and/or fuel dispenser 104 to generate an electrical detection signal applied to said control circuitry. Upon receipt of such a detection signal, display and control circuitry 110 may, for example, alter the content of display screen 140.

Those of ordinary skill in the art will appreciate that in alternate embodiments, the audio speaker 148 and the proximity detector 150 can be moved to locations on dispensing unit 102 or fuel dispenser 104 other than those shown in the Figures, as desired in a given implementation.

Display and control module 110 may include an area 152 for a decal used to communicate various types of information or promotional content to a customer. Finally, display and control module 110 is positioned on dispensing unit 102 at eye-level and within a customer's normal field of vision at the fuel dispenser 104, such that the module 110 is within a customer's line of sight and easy reach. For example, display and control module 30 in the disclosed embodiment is canted toward the customer at a 280 angle. In alternative embodiments, display and control module 110 can be mounted flush with fuel dispenser 102 or at higher or lower canting angles. Additionally, the display screen 140 and other components of the display and control module 110 can be integrated in a variety of a manners into the fuel dispenser 104 itself, in alternate embodiments.

As noted above, display and control module 110 incorporates one or more computers which can (1) by connection to a proximity detector 150 sense when a customer is within range of the device, (2) display various graphical and/or textual content to customers at the fuel dispenser, (3) interactively guide a customer through the selection of a product, (4) display the progress of a sale, (5) control the dispensing of a product, (6) communicate and receive a variety of authorization, sales, and transactional to and/or from a central network server.

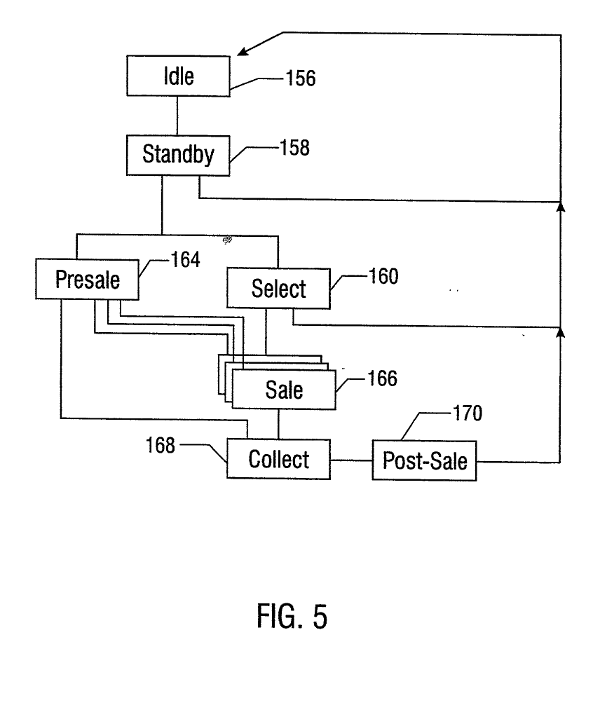

FIG. 5 is a state diagram of the state-specific display and control system logic employed by dispensing unit 102 in one embodiment of the invention. Through this system and associated electronic and computer-controlled systems integrated into dispensing unit 102, dispensing unit 102 monitors customer activity and operating conditions on a real-time basis at both dispensing unit 102 and the adjacent fuel dispenser 104. Such capability enables dispensing unit 102 to (1) change audiovisual content in response to customer activity or operating conditions on a real-time basis such that each customer at each dispensing unit 102 or fuel dispenser 104 at a site is presented with individual, position-specific audiovisual content, (2) direct and control the fuel additive injection process on a real-time basis, and (3) facilitate linkages to the various transaction authorization, control, processing, and data storage functions that are necessary for dispensing unit operation and integration of fuel additive transactions with the corresponding fuel transactions such that payment of the additives is accomplished by customers in the same form and manner as that of the fuel or other purchases.

The state-specific display system uses a finite state machine, operating on embedded computers preferably within each display and control module 110 connected by a local-area network to one or more computer servers, to simultaneously control audiovisual presentation and additive injection and control operations. The server(s) control the commercial and “back office” aspects of the sale, such as sales authorizations, billing, and interface to the station point-of-sale system, and storage of sales data. The server(s) also maintain sales and other historical data as desired or required by the Bureau of Weights & Measures or other state or federal regulatory agencies. The computer circuitry inside display and control module 110 generates the audiovisual display for screen 140 and controls the progress of a sale. Communications between the server(s) and each display and control module 110 within each dispensing unit 102 are facilitated through use of a real-time network protocol that enables constant, real-time interactions between the server(s) and each dispensing unit 102. Each display and control module 110 may be configured to record, maintain and/or transfer event and history logs on a real-time basis for storage on a server. This supports the server(s), maintenance of sales and other historical data as desired or required by Weights and Measures or other state or federal regulatory agencies as well the ability to review past operational events for analysis of code or equipment maintenance issues. The event logging methodology uses a variable, configurable debug level in which the level and volume of detail to be retained in the event log can be specified and/or adjusted as desired. Through use of the real-time network protocol to constantly inform the server(s) of dispensing unit or transaction conditions, the server(s) in tandem with each display and control module 110 use nonvolatile storage of network client data in tandem with battery back up on the network server(s) to enable the orderly transfer, storage and restoration of nonvolatile data. Other computers may be slaved in series or in parallel to accomplish various real-time functions. The use of the finite state machine facilitates interactivity between control operations, network communications, and the audiovisual interface.

The finite state machine includes capabilities to enable transactions in a variety of operating modes; payment by cash, credit or debit card either before or after fuel is pumped, with additive volume either preset based upon specification by the customer or automatically set by dispensing unit 102 in response to volume of fuel dispensed. Within each mode of operations, dispensing unit 102 monitors customer activity and equipment conditions at both dispensing unit and the fuel dispenser. Electronic signals are processed and acted upon by various of dispensing unit's electronic and computer circuitry. The state-specific events for one operating mode within the disclosed embodiment would be as follows.

With no customer at or in the vicinity of dispensing unit 102 or the fuel dispenser 104, dispensing unit is in the idle state represented by block 156. Dispensing unit 102 remains in this idle state 156 until a customer or automobile approaches. Various types of audiovisual content can be presented during idle state 156, such as a “screen saver” which can be seen by passing motorists. As a customer or automobile approaches dispensing unit 102 and/or fuel dispenser 104, proximity detector 150 senses their presence. Electronic signals are processed by the dispensing unit's electronic and computer circuitry and dispensing unit 102 enters into a standby state represented by block 158 in FIG. 5. Various state-specific audiovisual content can be presented during standby state 158. In one embodiment, the system can be configured to bypass the idle state 156 altogether, such that a transition from the idle state 156 to standby state 158 is automatically made whenever the state machine attempts to enter idle state 156.

Standby state 158 is exited by one of three means. If an additive selection button 117 on dispensing unit 102 is pressed, a select state is initiated, as represented by block 160. More than one select state 160 may be provided, if different pre-pay modes are available, for example. Alternatively, if a fuel hook (designated with reference numeral 162 in FIG. 1, for example) is activated by the customer at adjacent fuel dispenser 104, a presale state 164 is initiated. Finally, if no activity or change in equipment conditions at either dispensing unit 102 or adjacent fuel dispenser 104 is detected within a pre-selected time period, dispensing unit returns to the idle state 156.

From select state 160, various state-specific audiovisual content is presented. If the customer does not activate a fuel hook at the adjacent dispenser within a specified time period, dispensing unit returns to idle state 156. If the customer does activate a fuel hook 162 at adjacent fuel dispenser 104 within the specified time period, dispensing unit 102 enters a sale state 166. In the sale state 166, dispensing unit can present product-specific audiovisual content as it monitors fuel dispenser activity on a real-time basis, and directs and controls the precise injection of volume increments of fuel additives into the fuel refueling stream at the fuel dispenser through one of three presently contemplated dispensing modes. In a first dispensing mode, all fuel purchased is treated with additive regardless of when the additive selection was made. In a second dispensing mode, only fuel volumes that are dispensed subsequent to when an additive selection was made are treated with additives. In a third dispensing mode, a preset volume of additive is injected into the fuel, without regard to the volume of fuel dispensed.

Within each dispensing mode, dispensing unit 102 has the capability to vary the amount of each volume increment of additive or the point of injection corresponding to each volume increment of fuel. In addition, within each dispensing mode, dispensing unit 102 preferably has the capability to calculate whether or not the dispensed additive has traveled through the fuel hose and into the fuel tank. Those of ordinary skill in the art will appreciate that such capability is achieved by monitoring, in dispensing unit 102, the flow of fuel out of fuel dispenser 104, as well as perhaps such parameters as the flow rate. Additionally, control circuitry in display and control module 110 is preferably informed as to the volume of fuel which can be contained in the system between the point of additive injection and the point at which the stream of fuel exits hose 113. With this knowledge, the control circuitry can ensure that each injected increment of additive is expelled from hose 113 before that increment of additive is accounted for (i.e., charged to the customer). This feature advantageously prevents additive volume increments that have not reached the fuel tank from being billed to the customer. In addition, dispensing unit 102 preferably has the capability to display running total sale information for the product purchased on display screen 140 either by itself or simultaneously with the display of other video content on the screen.

Once the deactivation of a fuel hook at fuel dispenser 104 is detected (indicating that the fueling transaction has ended), dispensing unit 102 enters a collect state represented by block 168 in FIG. 5. Collect state 168 is a transition state in which fuel and/or additive transactional information is relayed to the central additive network server or the station retail point-of-sale system pending closing of the transaction. Once transactions are closed, dispensing unit 102 enters a post-sale state represented by block 170 in FIG. 5. From this state, sale amounts and other transactional data are transferred to data storage systems, which typically would be located at the central additive network server. Following the post-sale state 45, dispensing unit automatically reenters either the standby state 158 or the idle state 156.

From presale state 164 in which a fuel hook 162 at fuel dispenser 104 is activated but no additive button 117 is selected, dispensing unit presents various audiovisual content. If a fuel hook 162 at fuel dispenser 104 is deactivated prior to an additive selection button 117 being pressed by the customer (i.e. transaction ended), dispensing unit 102 enters collect state 168, and proceeds through subsequent states as indicated. If, on the other hand, an additive selection button 117 is pressed while dispensing unit 102 is in the presale state, dispensing unit 102 can present to the user various state-specific and/or product specific audiovisual content, after entering the aforementioned sale state 166. Thereupon dispensing unit 102 proceeds through subsequent states as previously described.

Dispensing unit 102 supports variable display content in a configurable manner such that any single state on any dispensing unit 102 at a site can incorporate a wide variety of state-specific graphics types and formats, such as still slides without audio or motion video with audio. Such different types and formats can be displayed on different areas of the video display screen simultaneously with different types and formats displayed on other display screen areas, if preferred.

The presentation of the state-specific audiovisual content and operating content sequences as described in FIG. 5 is for one operating mode only (payment via cash after the fueling transaction is completed). Those of ordinary skill in the art will appreciate that multiple combinations and forms of similar state-specific process may be used for each of multiple modes of operation (e.g. post-pay cash inside, post-pay via credit card at the fuel dispenser, prepay cash or credit inside, and so on), including multiple additional states which may be added before, during, or after the states described with reference to FIG. 5.

In FIG. 6, there is shown a state diagram illustrating the operation of the finite state machine of dispensing unit 102 in accordance with an alternative, and presently preferred, embodiment of the invention. The operation of the state machine illustrated in FIG. 6 can perhaps best be appreciated with reference to the following Table 1, which sets forth the operational status of dispensing unit 102 in each of the states. Table 1 further sets forth simple examples of the types of messages or content that might be displayed on display and control unit 110 in each of the states, it being understood that in actual implementation, such messages and content would likely be more “consumer friendly.”

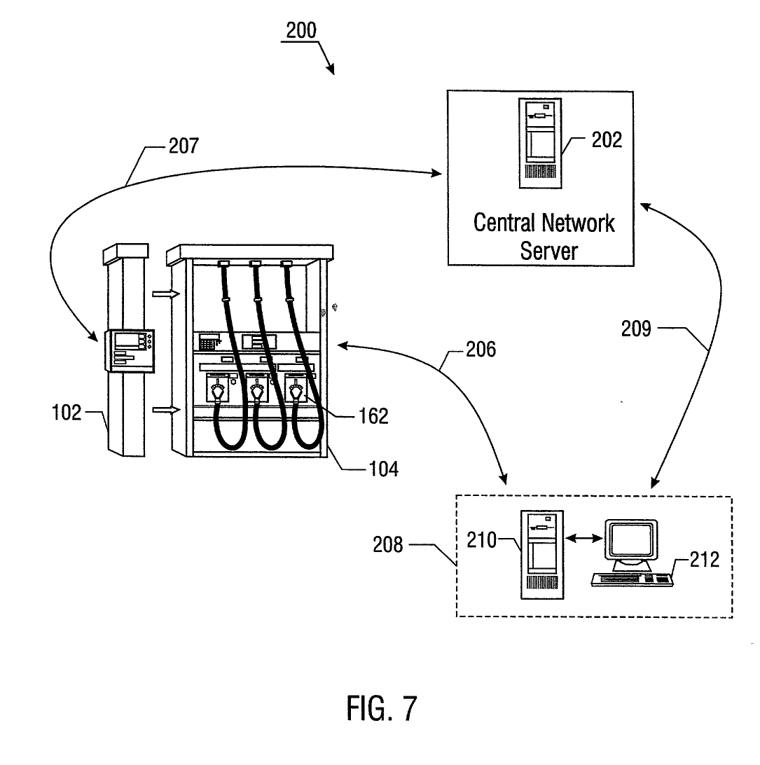

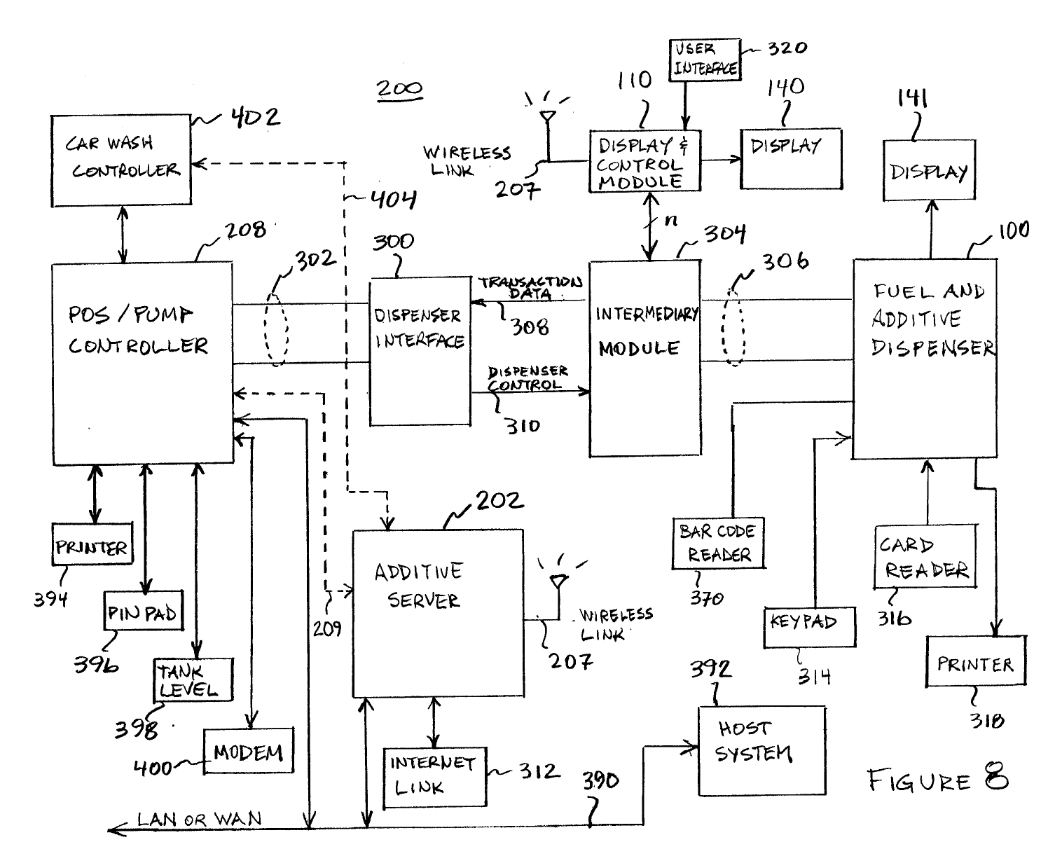

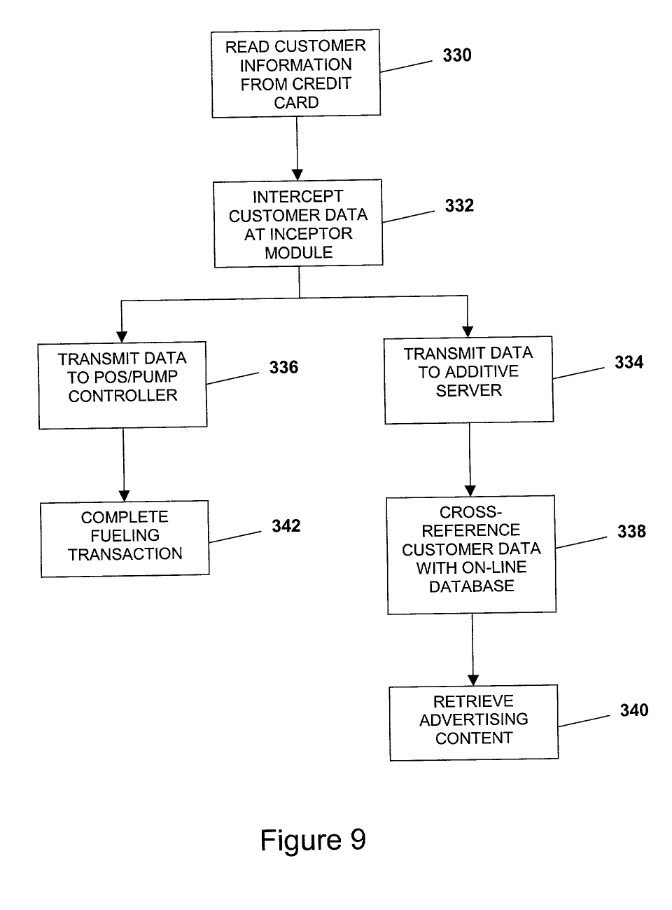

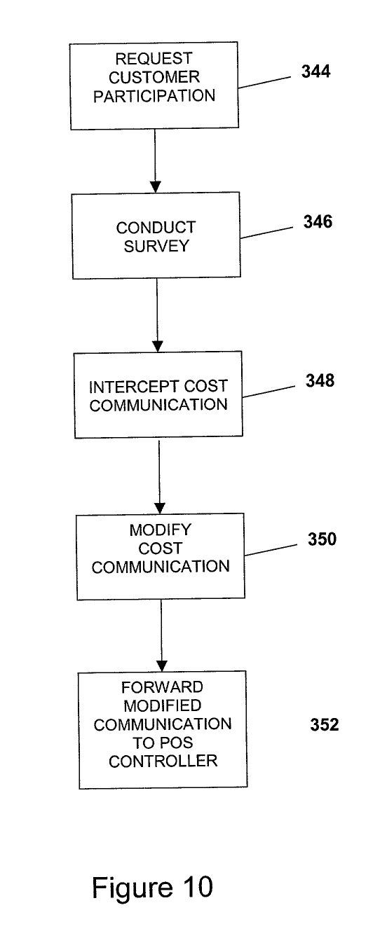

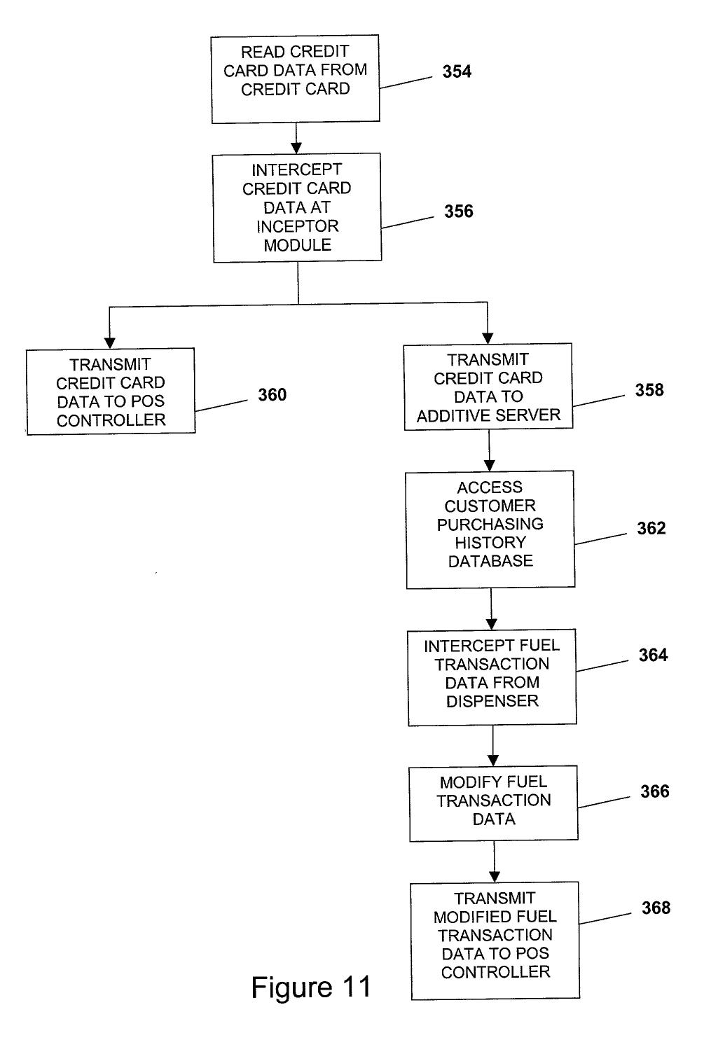

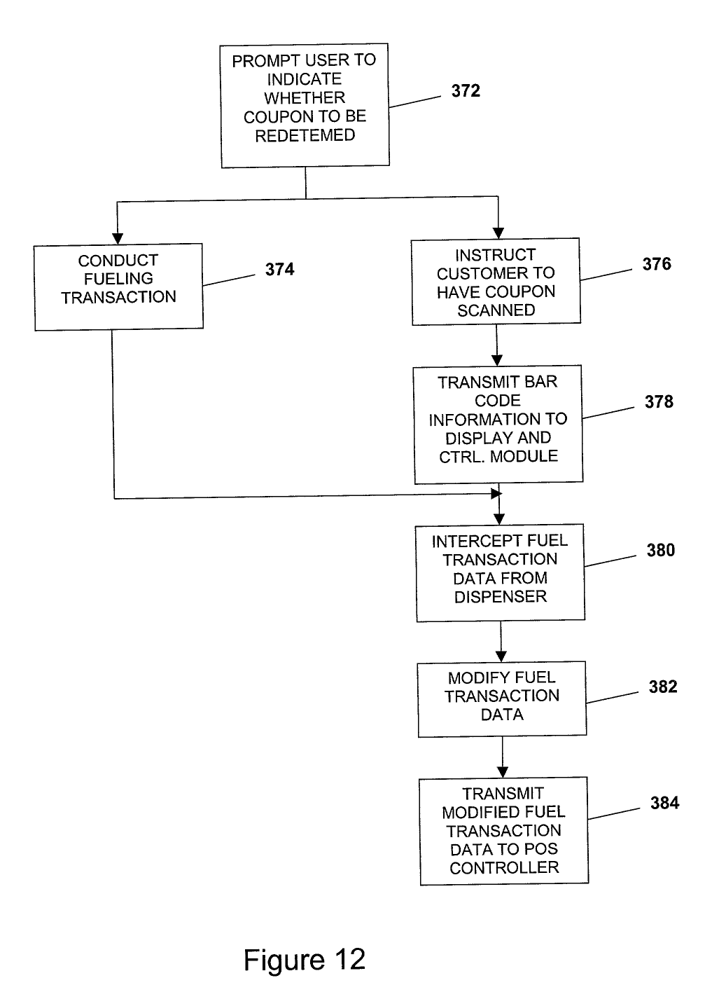

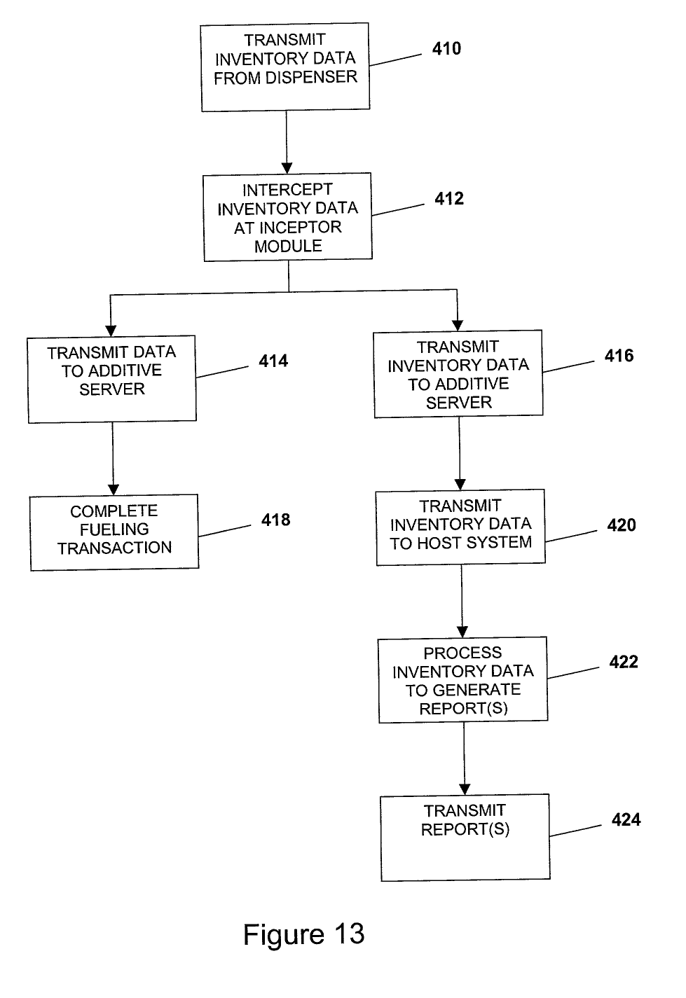

TABLE 1

| REF. | | | |
|---|---|---|---|
| No. | STATE NAME | DESCRIPTION | EXAMPLE MESSAGE |
| 172 | IDLE | This is the equivalent of a “screen | (Screensaver) |
| | | saver” on a desktop computer, | |
| | | corresponding to a situation in which | |
| | | dispensing unit 102 has been idle for | |
| | | some period of time and proximity | |
| | | detector 150 does not detect the | |
| | | presence of a customer. Display and | |
| | | control unit 110 may display advertising | |
| | | content, for example. | |
| 174 | STANDBY | The transition from IDLE to STANDBY | “Welcome.” |
| | | occurs upon the detection of a potential | |
| | | customer by proximity detector 150. In | |
| | | this state, display and control unit 110 | |
| | | may display content intended to | |
| | | encourage the potential customer to | |
| | | include an additive with his or her | |
| | | purchase. | |
| 176 | PRESALE | In this state, display and control unit | “Thank you for your fuel |
| | | 110 is aware that the customer is | selection; would you like |
| | | purchasing fuel, but no additive has | additive as well?” |
| | | been selected. Display and control unit | |
| | | 110 may display an inquiry as to | |
| | | whether the customer would like to | |
| | | purchase additive as well. | |
| 178 | POSTPAY | The POSTPAY state is entered when | “Transaction authorized.” |
| | | the customer has arranged to pay for | |
| | | fuel (and possibly additive) after fuel | |
| | | has been dispensed. An example of this | |
| | | is the familiar “Pay Inside Credit” option | |
| | | found on many conventional fuel | |
| | | dispensers. In the POSTPAY state, | |
| | | display and control unit 110 initiates a | |
| | | transaction by requesting authorization | |
| | | for a specific additive from the computer | |
| | | control circuitry (to be hereinafter | |
| | | described in further detail with reference | |
| | | to FIG. 7). The computer control | |
| | | circuitry replies with an authorized dollar | |
| | | amount. | |
| 180 | PUMP PAUSE | This state represents a pause in the | “Start fueling; your additive |
| | | operation of the state machine while | will be dispensed.” |
| | | fuel is being dispensed. | |
| 182 | FUEL SELECT | This state is entered when the customer | “Please select fuel before |
| | | selects an additive before selecting a | selecting an additive.” |
| | | fuel type. | |
| 184 | ADDITIVE | If display and control unit 110 is notified | “Is an additive desired?” |
| | SELECT | of a pre-paid transaction, it notifies the | |
| | | user to either select an additive or | |
| | | select no additive. For prepaid | |
| | | transactions, the computer control | |
| | | system initiates the additive transaction, | |
| | | and display and control unit 110 | |
| | | receives authorization for dispensing | |
| | | additive as soon as the customer | |
| | | begins the fueling transaction. | |
| | | Alternatively, display and control unit | |
| | | 110 can receive an authorization | |
| | | request which requires that an additive | |
| | | be selected before the sale can | |
| | | proceed. A customer can optionally | |
| | | specify “no additive.” | |
| 186 | NO SALE | This state is entered if display and | (no message) |
| | | control unit 110 is notified of a pre-paid | |
| | | transaction that is expressly not to | |
| | | include additive. | |
| 188 | SALE | This state is entered when dispensing | “Additive is being |
| | | unit 102 begins dispensing additive. | dispensed.” |
| 190 | COLLECT | This state is entered when the sale of | “Your sale is being posted. |
| | | additive is being posted to the point-of- | Please make payment as |
| | | sale system, after the dispensing of fuel | arranged.” |
| | | and additive has completed. | |
| 192 | POST-SALE | This state is entered after the sale of | “Thank you for buying |
| | | additive has been posted. | additive.” |
| 194 | INFORMATION | The transition from STANDBY state 174 | “Here are the additives |
| | | or PRESALE state 176 occurs if a | available, and this is what |
| | | customer requests information about | they do . . . ” |
| | | additives. | |
| 196 | ERROR | Several possible error conditions may | A message appropriate to |
| | | arise. For example, dispensing unit 102 | the type of error occurring |
| | | may be purposefully disabled. A | may be displayed. |
| | | customer's attempt to select an additive | Alternatively, the message |
| | | may be denied unless cash is paid in | “System disabled” may be |
| | | advance. The computer network | displayed. |
| | | controlling one or more dispensing units | |
| | | 102 (to be hereinafter described in | |
| | | greater detail with reference to FIG. 7) | |
| | | may be inoperative, preventing the | |
| | | dispensing of additive. Meters and | |
| | | gauges within dispensing unit 102 may | |
| | | detect an error during the attempted | |
| | | dispensing of additive. | |

Turning now to FIG. 7, there is shown a simplified block diagram of an overall fueling station retail transaction system 200 incorporating one embodiment of the present invention. Based on the description which follows, those of ordinary skill in the art will recognize that system 200 in FIG. 7 includes the principal components of current state-of-the-art retail fueling station systems, plus similar components to effect the incorporation of fuel additive dispensing capabilities in accordance with the principles of the present invention. System 200 includes one or more fuel dispensers 104 (for clarity, only one of which being shown in FIG. 7) having fuel additive dispensing units 102 associated therewith (again, only one of which being shown in FIG. 7). System 200 further comprises a central POS network server 210 to which each fuel dispenser 104 is connected via communication link 206. Further, POS network server 210 is coupled by communications link 209 to central additive network server 202 to which each fuel additive dispensing unit 102 is connected by a communications link 207. Communications link 209 enables the integration of fuel additive transactions with corresponding fuel transactions.

It is to be understood that communication links 206, 207, and 209 may take various forms. In some cases, communication links may be established by means of hard wiring, typical of conventional computer network configurations. Alternatively, communications links may be established for the purposes of the present invention via wireless (e.g., radio frequency or infrared) communication channels. In any event, for the purposes of the present disclosure, it suffices to describe communications links 206 as channels by which information regarding the operational status and transaction information of each fuel dispenser 104 can be transmitted to central POS server 210, communications link 207 as the channel by which the operational status and transaction information of each dispensing unit 102 can be communicated to central additive network server 202, and communications link 209 as the channel by which operational status or transaction information of a dispensing unit 102 can be communicated to central POS server 210 by way of central additive network server 202.

Central POS server 210 is commonly part of an existing station point-of-sale (“POS”) system 208. Module 212 is the “cash register” at which consumers can consummate transactions for the sale of fuel (and other items). Typically, POS system 208 is located within a store or kiosk at the fueling station. In one embodiment, POS system 208 comprises a computer 210 and user terminal 212. POS system 208 is also preferably coupled to each fuel dispenser 104 via a communications link 206 and to central additive network server 202 via a communications link 209 and by association to each fuel additive dispensing unit 102 via communications link 209

In general, each dispensing unit 102 is designed such that it can either be connected to POS system 208 through fuel dispenser 104, and/or it may be connected via network communication link 207 to central additive network server 202 supporting the various transaction authorization, control, processing, and data storage functions that are necessary for dispensing unit operation and the integration of fuel additive transactions with the corresponding fuel transactions such that payment of the additives can be made in the same form and manner as that of the fuel or other purchases. Due to the preferability of avoiding the extensive system hardware/software redevelopment that would be required to upgrade (e.g., retrofit) existing station point-of-sale systems to incorporate all required dispensing unit functionality, the disclosed embodiment contemplates the separate network control server alternative as depicted in FIG. 6.

In one embodiment, each dispensing unit 102 at a site location attaches to a fuel dispenser 104 and is connected to separate central additive network server 202 such that each dispensing unit 102 sends and receives sales authorizations and transactional data primarily to and from the central additive network server 202, and each fuel dispenser 104 sends and receives sales authorizations and transactional data primarily to and from the existing point-of-sale system 208. Both central additive network server 202 and the retail station POS system 208 are typically located inside a store or kiosk (not shown in FIG. 7). In a typical configuration, both the central network additive server 202 and retail station POS system 208 use network message communications protocols or other means to communicate via links 209 respectively with each dispensing unit 102 associated with a fuel dispenser 104.

In another embodiment, each dispensing unit 102 may be provided with a credit card reader for enabling a customer to pay for fuel additive separately from the fuel itself. Those of ordinary skill in the art will appreciate that such a credit card reader may be exposed on the face of display and control module 110 to enable a user to select and pay for a desired fuel additive. Control information regarding the selection of and payment for additive may be communicated to central additive network server 202 and/or POS system 208 in the manner described herein.

In a typical operating mode configuration (payment via cash after the fueling transaction is completed), a customer lifts a nozzle 162 at the fuel dispenser 104, and fuel dispenser 104 requests authorization from POS system 208. Once authorization is received, fuel dispenser 104 begins dispensing fuel. At such point that the customer selects an additive at dispensing unit 102, dispensing unit 102 monitors such selection, and requests authorization from central additive network server 202. Once authorization is received, dispensing unit 102 dispenses additive into the fuel refueling stream at the fuel dispenser 104 during the fuel refueling process under one of three dispensing modes as previously described. After the fueling transaction is completed, fuel dispenser 104 transmits fuel sale information to POS system 208, and dispensing unit 102 transmits fuel additive sale information to central additive network server 202. By means of computer network integration, POS system 208 then receives the fuel additive sale information from central additive network server 202 such that the fuel additive sale information can be matched with and posted to the corresponding fuel sale information. In this manner, the customer can pay for the cost of the fuel additive purchase at the same time and place, and in the same form and manner, as that of the fuel or other purchases.

In another operating mode configuration (payment via cash prior to a fueling transaction being initiated in which a preset amount of additive is requested by the customer), a customer pays the cashier inside the store or kiosk and returns to fuel dispenser 104. Through computer integration means, POS system 208 sends a preset additive volume message to central additive network server 202 indicating the selected additive amount and the designated fuel dispenser 104. Central additive network server 202 authorizes the corresponding dispensing unit 102 and such dispensing unit 102 dispenses additive into the fuel refueling stream at the fuel dispenser 104 during the fuel refueling process under one of three dispensing modes as previously described. After the fueling transaction is completed, fuel dispenser 104 transmits fuel sale information to POS system 208, and dispensing unit 102 transmits fuel additive sale information to central additive network server 202. By means of computer network integration, POS system 208 then receives the fuel additive sale information from the central additive network server 202 for ensuing processing.

In yet another operating mode configuration (payment via cash prior to a fueling transaction being initiated in which the customer is not required to specify his/her desire for an additive at the time of prepayment), a customer pays the cashier inside the store or kiosk and returns to the fuel dispenser 104. Through computer integration means, POS system 208 sends a prepay fuel volume message to the central additive network server 202 indicating the total prepaid amount and the designated fuel dispenser 104. POS system 208 also delays authorization of the appropriate fuel dispenser 104 pending receipt of a prepay allocation message from central additive network server 202. Central additive network server 202 informs the appropriate dispensing unit 102 of such prepay condition, and such dispensing unit monitors ensuing customer selections of fuel and fuel additive, and informs the central network server of such selections. If no additive is selected, central additive network server 202 sends a prepay allocation message to POS system 208 indicating that 100% of the prepaid amount should be allocated to fuel. POS system 208 then authorizes the appropriate fuel dispenser 104 for such amount. If, however, an additive is selected, central additive network server 202 uses a prepay allocation algorithm to calculate the respective amounts of fuel and additive that should be dispensed, based on the total prepaid amount, the fuel grade and additive type selected and their respective retail prices and fuel additive treat rate (i.e., the volume of additive dispensed per volume of fuel dispensed). After such calculation, central additive network server 202 sends a prepay allocation message to POS system 208 indicating the amount of the prepaid amount to be allocated to fuel. POS system 208 then authorizes the appropriate fuel dispenser 104 for such amount, and central network additive server 202 authorizes the appropriate dispensing unit 102 for the prepaid amount to be allocated to the selected additive. Dispensing unit 104 then dispenses additive into the fuel refueling stream at the fuel dispenser 104 during the fuel refueling process under one of three dispensing modes as previously described. After the fueling transaction is completed, fuel dispenser 104 transmits fuel sale information to POS system 208, and dispensing unit 102 transmits fuel additive sale information to central additive network server 202. By means of computer network integration, POS system 208 then receives the fuel additive sale information from central additive network server 202 for ensuing processing.

In yet another operating configuration (a prepaid fuel-only transaction in which a customer specifies to the cashier that no additive is desired), a customer may prepay to the cashier. The station POS system 208 sends a message via communications link 209 informing central additive network server 202 of a fuel-only prepay transaction. In this case, central additive network server 202 “disables” the respective dispensing unit 102 for the duration of the fuel transaction.

The description of such communications and operations for the various operating mode configurations are but one of many similar processes that systems in accordance with the present invention may employ, depending on the type of point-of-sale system and the overall mode of operation (e.g. post-pay cash inside, post-pay via credit card at the fuel dispenser, prepay cash or credit inside, etc.) to direct, control, and process transactions. Such communications protocols for such communications can be via network messages or serial port communications in a variety of forms and manners, as would be familiar and appreciated by those of ordinary skill in the art. In total, systems in accordance with the present invention support a wide variety of configurations, including the inclusion or integration of some or all dispensing unit control and functional capabilities within the fuel dispenser and station POS system 208 if desired. As with this and other aspects of the invention, it will be apparent to those of ordinary skill in the art that many embodiments of the subject invention may be designed that are not described in specific detail herein.

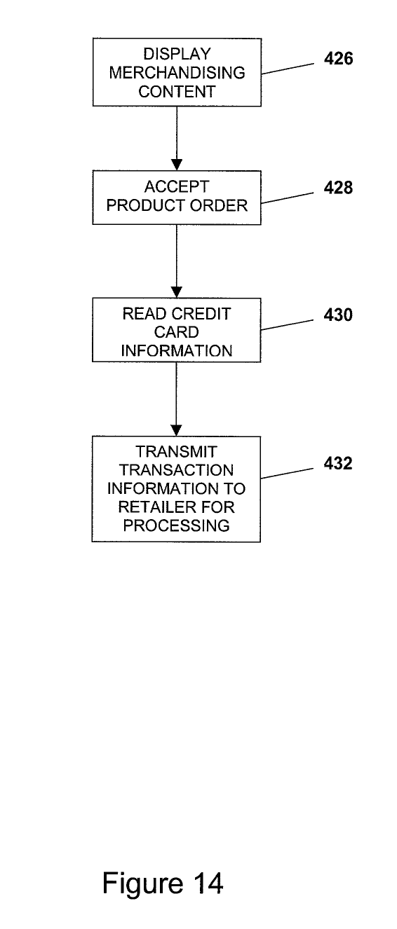

Turning now to FIG. 8, there is shown a somewhat more detailed functional block diagram of fuel and additive dispensing system 200 in accordance with the presently disclosed embodiment of the invention. As noted above, an important feature of the present invention resides in the avoidance of extensive system hardware and software redevelopment that would be required to upgrade or retrofit existing point-of-sale systems to incorporate all required additive dispensing functionality. As those of ordinary skill in the art will appreciate, a conventional point-of-sale fuel dispensing system comprises two primary components: the point-of-sale controller 208 and the fuel dispenser 100. Those of ordinary skill in the art will further appreciate that various point-of-sale controllers are commercially available from various manufacturers. Likewise, various fuel dispensers are commercially available from different manufacturers. Presently, there is no one universal control signal protocol that has been established for defining the interface between a point-of-sale controller and a fuel dispenser. Indeed, often the communications protocol between a point-of-sale controller and a fuel dispenser is maintained as proprietary information to the manufacturer(s) of the equipment in question. Therefore, in order for a particular fuel dispenser to be used with and interact with a particular point-of-sale controller, an interface specific to the make and model of the fuel dispenser and to the make and model of the point-of-sale controller must be provided.

Point-of-sale/pump controllers are well known. One example of a point-of-sale controller with which the present invention may be practiced is the Tokheim Pro II POS/pump controller, commercially available from Tokheim Corporation, Fort Wayne, Ind. Another is the VeriFone Ruby POS/pump controller commercially available from VeriFone, Inc., Santa Clara, Calif. Still another is the Autogas Regal Series of POS/pump controllers, commercially available from Autogas Corporation. Likewise, a variety of fuel dispensers are known and commercially available, including the Tokheim Centurion fuel dispenser, the Gilbarco Advantage fuel dispenser, and the Wayne 590 series of dispensers.

In FIG. 8, a dispenser interface 300 is shown. Dispenser interface 300 is coupled to point-of-sale system 208 by means of a link 302 which may be, for example, an RS232 or an RS485 serial communications link. In a conventional system, dispenser interface 300 would be coupled directly to fuel dispenser 100, and serves to intermediate communication of dispenser control signals between fuel dispenser 100 and point-of-sale controller 208. For example, customer selections at the fueling station 100 would be communicated to controller 208 via interface 300, as would, for example, credit card data. Similarly, dispenser control signals and associated data issued by controller 208 would be communicated to dispenser 100 via interface 300. (As used herein, the term “control signals” is intended to encompass both control signals and associated data, which may be transmitted or communicated from point to point in the form of analog or digital signals. The concept of “intercepting” control signals shall be understood for the purposes of the present disclosure to encompass receipt of signals of various forms such that the signals may be effectively interpreted, manipulated, transformed, retransmitted, and/or redirected to one or more functional components. It is contemplated that signals may be analog, digital, or both.)

Examples of well-known and commercially available dispenser interfaces include the Tokheim Access Module (TAM), the Gilbarco Pump Access Module (PAM), and the Wayne EC Electronic Controller.

In accordance with an important aspect of the present invention, on the other hand, system 200 as shown in FIG. 8 incorporates an additional intermediary module in the communication path between controller 208 and fuel dispenser 100. In the disclosed embodiment, this intermediary module, designated with reference numeral 304 is sometimes referred to as an “Inceptor” module 304 (“Inceptor” being a shortened form of “interceptor,” reflecting in part the functionality of module 304, as will hereinafter become apparent).

As is apparent from FIG. 8, intermediary module 304 serves in part as a bi-directional interface between fuel dispenser 100 and dispenser interface 300. Intermediary module 304 communicates with fuel dispenser 100 by means of a link 306. In one embodiment, link 306 comprises a proprietary current loop communications channel, although it is contemplated that other communications links, such as an RS485, RS422, or twisted pair link, may be used. intermediary module 304 provides transaction data (e.g., customer data including credit card data, customer selection information, and the like) on line(s) 308 to dispenser interface 300 and receives dispenser signals (control signals and the like) on line(s) 310 from dispenser interface 300. In accordance with one aspect of the invention, the presence of intermediary module 304 is essentially transparent to dispenser interface 300; that is, dispenser interface communicates with intermediary module 304 on lines 308 and 310 in exactly the same manner as if it were communicating directly with fuel dispenser 100, as it would in a conventional point-of-sale fuel system.

In addition to serving as a transparent interface between dispenser interface 300 and dispenser 100, however, intermediary module 304 notably serves to provide an interface to display and control module 110 associated with the fuel additive dispensing capabilities of system 200. In this way, display and control module 110 is capable of monitoring, injecting, intercepting, filtering, capturing, converting, and/or modifying communications between fuel dispenser 100 and dispenser interface 300.

Intermediary module 304 in the presently disclosed embodiment consists of two primary components: a CPU module and a personality module. In one embodiment, the CPU module and the personality module are disposed upon a printed circuit board. CPU module comprises a microcontroller, random-access memory (RAM), flash read-only memory (flash ROM), and a system clock. Software for controlling operation of the microcontroller is preferably stored as firmware in the flash ROM and can be uploaded or updated via display and control module 110, as will be hereinafter described. It is believed that the design of the CPU module to perform the functions described herein would be a matter of routine engineering to persons of ordinary skill in the art, and the details of implementation of the CPU module will be evident to those of ordinary skill in the art based upon the functional description provided herein.

The personality module electronically converts and conditions electrical signals to and from dispenser 100 on link 306 and lines 308 and 310. Since, as noted above, each dispenser manufacturer adopts its own respective signal specification and communication protocol, a different personality module is necessary for each make and model of dispenser as needed. Preferably, the personality module is implemented as a modular component of intermediary module 304, such that different personality modules may be utilized in any given implementation of the invention on a case-by-case basis. This greatly enhances the flexibility and versatility of the invention to be adaptable for use with many different makes and models of fuel dispensers.

The personality module component of intermediary module 304 converts the electrical signals communicated between dispenser interface 300 and fuel dispenser 100 to a form usable by the CPU module, while the firmware on the CPU module can be programmed to monitor, inject, intercept, filter, convert, capture, and/or modify the protocol between the dispenser and the point-of-sale controller 208. intermediary module 304 is programmable to notify display and control module 110 of events reflected in the communications stream between the point-of-sale controller 208 and dispenser 100 and to accept commands from display and control module 110 regarding operation.

With continued reference to FIG. 8, and as discussed generally with reference to FIG. 7, a communications link 207 is established between display and control module 110 and additive server 202. In a presently preferred embodiment of the invention, communications link 207 is a wireless channel operating at a carrier frequency of, for example, 2.4 gigahertz. Communications link 207 enables display and control module to be controlled by additive server 202, and provides a channel through which media data of various forms may be downloaded to display and control module 110 for display on display 140.

Preferably, additive server 202 is also provided with a link 312 to the Internet, thereby enabling multiple additive servers 202 in geographically separated locations to be commonly monitored and controlled from a central control location, and for media content and other data to be provided to additive server(s) 202 in real-time from the central location.

Various exemplary functions of intermediary module 304 are described below; those of ordinary skill having the benefit of the present disclosure will appreciate from the examples below how the present invention—the intermediary module 304 in particular—significantly increases the versatility of fueling system 200.

A typical fueling transaction in a conventional fueling system typically involves the following steps: First, a customer will make various selections using a keypad 314 on the dispenser 100. The customer selection information may include, for example, the type of fuel desired and the method of payment (e.g., whether the customer desires to “pay at the pump” or, where applicable, at a nearby kiosk or store, whether the customer desires to pay using a credit card, a debit card, or cash, whether the customer wants a receipt to be printed, and so on). This customer data is transmitted from dispenser 100 to dispenser interface 300, and then from dispenser interface to the point-of-sale controller 208. Point-of-sale controller 208, in response to the customer selection data, generates appropriate control signals to control operation of dispenser 100 in the selected manner. This dispenser data is transmitted from point-of-sale controller through dispenser interface to dispenser 100, where the fueling operation commences. In some cases, the customer will elect to pay at the pump using a credit or debit card. In this case, a card reader 316 is preferably provided to read the customer's card. The card information is transmitted from dispenser 100 to point-of-sale controller 208 (via dispenser interface 300) for processing. Upon authorization of the transaction, point-of-sale controller 208 transmits further control signals to dispenser 100 to initiate the fueling operation.

A display 141 on dispenser 100 displays such information as the amount of fuel dispensed, the dollar amount of the transaction, and possibly a brief textual message (e.g., “Thank you for shopping at this location”). Upon completion of the fueling operation, the customer will return the dispenser hose to its cradle; this event is signaled to point-of-sale controller, which might then issue further control signals to initiate the printing of a receipt by a printer 318.

The presence of intermediary module 304 in the communications channel between dispenser and point-of-sale controller 208 provides the opportunity for significant enhancements to a fueling transaction. intermediary module 304 monitors the communication from dispenser 100 and thereby can detect the initiation of a fueling transaction. This information is relayed to display and control module 110, which then presents additional content on display 140. As noted above. this content can take virtually any form, including, notably, full-motion video and audio. For example, the equivalent of a television commercial extolling the benefits of using a fuel additive can be presented. In accordance with one aspect of the invention, the content displayed on display 140 is preferably downloaded from additive server 202 via link 207 and buffered in memory associated with display and control module. Moreover, through the Internet link 312, new content can be provided to additive server 202 at any time, continuously, and/or in real-time.

Display and control module 110, in cooperation with intermediary module 304, further provides the opportunity for increased customer interaction before, during and after a fueling transaction. A user interface 320, which may be a keypad, keyboard, touch screen, pointing device, or the like, enables the user to interact with display and control module in response to content being displayed on display 140. For example, display 140 can display a list of all available additives and invite the user to select an additive to be dispensed using interface 320. Display and control module 110, in turn, can control intermediary module 304 to inject a communication onto communications link 306 to cause the selected additive to be dispensed. From the perspective of dispenser 100 there is no way to determine that the command to dispense additive is being initiated by intermediary module 304, rather than by point-of-sale controller by way of dispenser interface. This is another example of the transparency integration of intermediary module 304 into an existing system, which is believed to be a significant and advantageous feature of the present invention. At the same time as intermediary module 304 is instructing dispenser to dispense additive, display and control module 110 notifies additive server 202 of the customer's selection via link 207.

As shown in FIG. 8, additive server 202 may or may not be directly coupled to point-of-sale controller 208, as represented by dashed line 209. The option of not coupling additive server to point-of-sale controller 208 may be desirable from the standpoint of making the integration of the fuel additive functionality of system 200 completely seamless, i.e., requiring no modification to the hardware or software of an existing (e.g., non-additive-capable) fueling system.

Display and control module 110 and intermediary module 304 also play an important role in integrating the sale of an additive into a single point-of-sale transaction (as opposed to having separate transactions for fuel and for additive. In one embodiment, intermediary module 304 is adapted to intercept communications from dispenser 100 relating to the amount of fuel dispensed, and to automatically modify such communications to reflect the increased cost for additive. Point-of-sale controller 208 can have no way of determining that intermediary module 304 has made such a modification, and will process the transaction as usual. Again, this highlights the seamlessness with which the present invention may be integrated into existing fueling systems.

Continuing to refer to FIG. 8, in accordance with one aspect of the invention, POS controller 208 is coupled to a local-area network (LAN) and/or wide-area network (WAN), designated with reference numeral 390 in FIG. 8. A LAN 390 may be provided, for example, to interconnect multiple fueling systems 200 at a gas station, as is often the case. LAN 390 may further be part of a wide-area network, for example a network interconnecting the fueling stations 200 present at multiple gas stations throughout a city or even larger geographical regions. Such an arrangement also makes it possible for the operation of multiple fueling stations 200 at multiple locations to be controlled and monitored from a central location, for example at a central host system such as that designated with reference numeral 392 in FIG. 8.

In one embodiment, host system 392 performs the functions of monitoring the operation of fueling system(s) 200, including monitoring such parameters as amounts of fuel dispensed, revenue, inventory, and the like, and to generate reports on the operation of fueling system(s) 200. Likewise, as shown in FIG. 8, additive server 202 is preferably also coupled to LAN/WAN 390. In this way, host system 392 is capable of monitoring and controlling operation of additive server 202, and, in turn, display and control module 110. In one embodiment, the multimedia content displayed on display 140 (under control of display and control module 110) can be provided to display and control module by host system 392 instead of, or in addition to, such content being supplied to system 200 by means of Internet link 312, as previously described.

POS/pump controller 208 may have various peripheral components of its own, as is often the case in conventional fueling systems. Such peripheral components may include, for example, a printer 394 for printing receipts and the like, a keypad 396 for enabling customers to enter personal identification numbers (PINs) when making in-store purchases instead of pay-at-the-pump purchases, a tank level sensor 398 for monitoring the amount of fuel in the station's storage tank(s) (i.e., inventory), and a modem for enabling controller 200 to communicate with a remote system such as a credit card validation system or the like. Those of ordinary skill in the art will recognize this as a more or less conventional arrangement.

In addition, many commercial POS/pump controllers are adapted to interface with a car wash controller module, for gas stations which have an on-site automated car wash facility. A car wash controller 402 is shown in FIG. 8. In accordance with conventional practice, car wash controller 402 is interfaced with POS controller so that customers can purchase a car wash as part of a single fuel transaction. As described above, system 200 in accordance with the presently disclosed embodiment, represents an even further enhancement inasmuch as fuel, car wash, and additive can be purchased as part of a single, integrated transaction.

Those of ordinary skill in the art will appreciate that in conventional systems, car wash controllers such as car wash controller 402 must be configured based upon such factors as the type of POS/pump controller used, the type of car wash equipment provided, the different products (soaps, rinsing agents, waxes, etc . . . ) provided in the car wash equipment, and so on. To accomplish such configuration, car wash controllers are often provided with a keypad or other interface (such as switches or the like) to customize the configuration of car wash controller on a case-by-case basis.

In the presently disclosed embodiment, on the other hand, additive server 202 can be utilized to facilitate the configuration process for car wash controller 402. First, information about the configuration is provided to additive server 202, for example, via Internet link 312, or from host system 392. An interconnection 404 between additive server 202 and car wash controller 402 is provided so that additive server 202 can automatically configure car wash controller 402 in a “plug-and-play” manner. This advantageously eliminates the need for human intervention in the configuration of car wash controller 402. Additionally, due to the presence of link 404 between car wash controller 402 and additive server 202, operation of car wash controller 402 can be controlled and monitored remotely, either by host system 392 or by any other computer system via Internet link 312.

The versatility of the present invention provides virtually limitless opportunities for enhanced point-of-sale transactions associated with fueling stations. The following are but a few examples:

Systems Monitoring and Inventory Management

The architecture of fueling system 200 in accordance with the disclosed embodiment(s) of the invention supports a highly efficient methodology for the monitoring of one or more fueling systems (which are preferably networked via a LAN or WAN as described hereinabove) as well as the management of inventories of fuels, additives, and other associated products. The flow diagram of FIG. 13 illustrates one example of this functionality.

With reference to FIG. 13, a first step in the process of system monitoring and inventory management involves the transmission of inventory data from a dispenser unit 100. Those of ordinary skill in the art will appreciate that such inventory data may comprise, without limitation, such information as the flow rate at which fuel is dispensed from dispenser 100, the total volume of fuel dispensed, the dollar value of a transaction, and so on. This is represented by block 410 in FIG. 13. Next, the inventory data is intercepted (block 412) by intermediary module 304. Thereafter, the inventory data is transmitted both to POS/pump controller 208 (block 414) (via dispenser interface 300) and to additive server 202 (via display and control module 110 and wireless link 207), as represented by block 416 in FIG. 13.

On the POS/pump controller side, the fueling transaction can proceed as usual, as represented by block 418 in FIG. 13, with POS/pump controller 208 being entirely unaware of the interception of the inventory data by intermediary module 304. In parallel, as represented by block 420, the inventory data is communicated to host system 392 via LAN/WAN 390, or, alternatively, by means of Internet connection 312 (it being understood that host system 392 may be provided with its own Internet connection (not shown)).

In block 422, the inventory data is processed. Such processing may include, by way of example but not limitation, the incremental updating of values reflecting the current inventory of fuel, additive, and associated products as effected by the current transaction, revenue statistics, pump flow performance statistics, and the like. The processing of inventory data in one embodiment culminates in the generation of reports reflecting current inventor status, pump performance (which those of ordinary skill in the art can be interrelated to the inventory status), and so on.

A further step, represented by block 424 in FIG. 13, can involve the transmission of status reports to appropriate recipients by appropriate means. For example, the inventory data may reflect poor (or non-existent) performance of a particular dispenser (as reflected, for example, by flow rate data) indicating the need for a service call to repair the dispenser 100. The inventory data may reflect the a level of inventory calling for replenishment of fuel, fuel additive, or associated products. The transmission of status reports represented by block 424 can be in any of various forms, including transmission over LAN/WAN 390, automated facsimile transmission, email notifications, and the like.

Order Entry System

The configuration of fueling system 200 in accordance with the disclosed embodiments admits to its functionality as a stand-alone order entry system whereby customers may utilize system 200 to engage in retail transactions separately and/or in parallel with a fueling transaction—essentially an “on-line” retailing system. FIG. 14 is a flow diagram illustrating one such example. Notably, the process depicted in FIG. 14 does not necessarily involve the purchase of fuel or additive; a retail transaction such as depicted in FIG. 14 can occur before, during, and/or after a fueling transaction. An order entry transaction can be commenced during a fueling transaction and can conclude either before or after conclusion of a fueling transaction.

As shown in FIG. 14, the first step in the order entry process (block 426) involves presentation of merchandising content on display 140. As previously described, the merchandising content can be of various forms, including textual, graphical, full-motion video, and audio components. The content can originate from various sources, including host system 392, additive server 202, or any Internet-connected source (via Internet link 312). Ultimately, the content is provided to (and in some cases stored permanently or temporarily in) display and control module 110. The merchandising content can comprise multiple “pages” or screens of content through which a customer can navigate using user interface 320.

It is contemplated that virtually any goods or services may be offered to the customer. Examples include, without limitation, food and beverage items, automotive supplies, maps, retail merchandise of all varieties, and so on. Merchandise selected for purchase may be available to the customer immediately, for example at a kiosk or convenience store associated with the fueling station 200; alternatively, the transaction may involve having the selected merchandise shipped directly to the customer's address at a future time. Advantageously, because the transaction involves obtaining the customer's credit card information, the customer's address can be accessed by system 200 without requiring the customer to provide it manually (although manual entry of shipping information and the like can be accomplished using user interface 320).

Using user interface 320, a customer can select goods or services for purchase, as represented by block 428 in FIG. 14. Thereafter, the customer is prompted to insert a credit card into card reader 316, such that the credit card information can be read. The customer's credit card information and the related transaction information (i.e., identification of the customer's selection) is captured by intermediary module 304 and provided to display and control module 110 for transmission via wireless link 207 to additive server 202, and from additive server to the appropriate retail center for processing of the transaction; this is represented by block 432 in FIG. 14. The retail center may be on-site, such that the transaction information is communicated by LAN/WAN 390, or at a remote location, such that the transaction information is communicated to host system 392, or to a third-party transaction processing system via Internet link 312.

Targeted Advertising

The flow diagram of FIG. 9 illustrates one example of how system 200 may be used as an advertising vehicle. When a customer's credit or debit card is read by card reader 316 (block 330), certain information about the customer is among the data transmitted from dispenser 100 to point-of-sale controller. intermediary 304 can be programmed to intercept this data (block 332) and transmit it to display and control module 110, and from display and control module to additive server 202 (block 334). As can be seen in FIG. 9, in parallel with transmission to additive server, intermediary module 304 also transmits the necessary information to POS controller 208 (block 336), such that POS controller 208 is unaware of the interception of the data by intermediary module 304 as it completes the fueling transaction (block 342).

Upon receipt of the intercepted customer information in block 334, additive server 202, in turn, may cross-reference the customer data with one or more private or public on-line databases (block 338) using Internet link 312. Those of ordinary skill in the art will appreciate that this can enable server 202 to retrieve customized advertising content (block 340), for display on display 140, that is specifically targeted to the customer based on, for example, past purchasing histories, demographic characteristics, geographic location, and so on. The advertising content can be displayed while the fueling transaction between POS controller 208 and dispenser 100 is completed as normal (block 342). As described above, display and control module 110 and display 140 are preferably “web-enabled,” such that the advertising content can be of any of various media formats, including .jpg, .bmp, and .gif images, mpg full-motion video, and the like, and may even be accompanied by associated audio content (e.g., .wav files).

As noted above, the advertising content retrieved in block 340 can be stored locally in display and control module 110, or, alternatively, in additive server 202, or even at a remote location accessible via Internet link 312. The advertising content may be in essentially any form, including text, static graphics, streamed audio and/or video, or combinations thereof.

Interactive Surveys

The flow diagram of FIG. 10 illustrates how system 200 may be used to conduct interactive surveys and the like with customers during a fueling transaction. First, display and control module 110 may present an inquiry on display 140 as to whether the customer would care to participate in the survey (block 344). The request may be accompanied by some incentive, such as an offer to discount the cost of the transaction if the survey is completed. If the customer responds affirmatively, additive server 202 can retrieve the content of the survey via Internet link 312 and present the survey on display 140 (block 346). Notably, the content of the survey may be provided by a third party not associated with the fueling station operator. The survey can be completely interactive, in that the customer's responses (entered through interface 320) can be transmitted via the Internet to the survey-taking entity in real time. In this way, the survey can be customized in real time based upon the responses given by the customer.

Upon completion of the survey, display and control module 110 may instruct intermediary module 304 to intercept data transmissions from dispenser 100 identifying the cost of the fueling transaction (block 348), and to automatically modify the transmission to reflect a discounted amount (block 350), for example, before forwarding the transmission to point-of-sale controller 208 (block 352). As in previous examples, the discounting of the transaction is completely transparent to point-of-sale controller 208.

Frequent Purchaser Rewards

System 200 in accordance with the presently disclosed embodiment of the invention can also support frequent purchaser reward programs. For example, a fuel company may wish to offer periodic discounts to all customers who regularly use that company's credit card to purchase fuel and/or additive. As shown in the flow diagram of FIG. 11, this can be accomplished as follows: First, the customer's credit card would be read by card reader 316 (block 354). Next, as in the flow diagram of FIG. 9, intermediary 304 intercepts the customer and card data as it is transmitted to point-of-sale controller 208 (block 356). The intercepted data is transmitted to additive server 202 via display and control module 110 and link 207. At the same time, intermediary module 304 transmits the necessary credit card data to POS controller 208 for normal processing.

Via Internet link 312, the intercepted customer data provided to additive server 202 can be used to access a frequent purchaser database maintained on-line (block 362). For example, the credit card issuer can maintain a database of the purchasing history of each cardholder.

One possible frequent purchaser incentive program would be, for example, a free or discounted amount of fuel after a cardholder makes a certain number of fuel purchases (e.g., “buy ten fill-ups and get the eleventh at half-price”). With continued reference to FIG. 11, then, for a given transaction in which the customer's purchasing history reveals that the customer is entitled to a discount for the fueling transaction, the next step is, upon completion of the fueling process, for intermediary module 304 to intercept the fuel transaction data transmitted from dispenser 100 to POS controller 208, as represented by block 364. Display and control module can modify the fuel transaction data (block 366) as appropriate (e.g., subtracting an appropriate amount from the data reflecting the amount of fuel actually dispensed), before transmitting the modified fuel transaction data to POS controller 208 (block 368). As in previous examples, the modification of the fuel transaction information would be transparent POS controller 202.

Coupon Processing

In accordance with one aspect of the invention, in one embodiment the inventive system may be utilized for the processing (generating and redemption of) coupons during a fueling transaction.

As previously discussed, dispenser 100 preferably has a printer 318 associated therewith to print customer receipts and the like. Indeed, printers in fuel dispensers are quite common in modern commercial gas station dispensing units. In a conventional arrangement, printer 318 functions to print customer receipts as instructed by commands from POS controller 208. In systems in accordance with one embodiment of the present invention, printer control commands may be generated by display and control module 110 and directed to printer 318 via intermediary module 304. In such cases, the fact that the printer commands are being generated by display and control module 110 instead of POS controller 208 is transparent to printer 318.

In one embodiment, display and control module 110 is programmable to cause printer 318 to print a coupon for a customer. For example, a coupon could be the incentive offered in connection with the interactive survey described with reference to FIG. 10, or as the reward for frequent customers discussed with reference to FIG. 11. Alternatively, a coupon might be printed for every customer, or for periodic/random customers. Owing to the ability of intermediary module 304 to intercept fuel transaction information transmitted from dispenser 100, the dollar value of the coupon can be changed depending, for example, upon the amount of fuel dispensed.

In one embodiment, coupons printed by printer 318 under control of display and control unit may include a bar code encoding the value of the coupon and related information. In addition, in the disclosed embodiment of the invention, fuel dispenser 100 is equipped with a bar code reader 370, as shown in FIG. 8. If dispenser is so equipped, it is then possible for a customer to redeem a coupon at dispenser 100. One implementation of this process is depicted in the flow diagram of FIG. 12.

In the disclosed example, a fueling transaction involving redemption of a coupon begins at block 372 with display and control module 110 prompting the customer, on display 140, to indicate using user interface 320 whether a coupon is to be redeemed in connection with the fueling transaction. Assuming that the customer responds affirmatively, the fueling transaction commenced, as represented by block 374. During (or, alternatively after) the fueling transaction, messages can be displayed on display 140 providing instructions to the customer for redeeming the coupon. The customer is instructed to have the coupon scanned by bar code reader 370 (block 376); the bar code coupon information is then transmitted to display and control module 110 (block 378).

Upon completion of the fueling process, intermediary module 304 intercepts the fuel transaction data from the dispenser and transmits it to display and control module 110, as represented by block 380. Display and control module 110 modifies the fuel transaction data in accordance with the coupon bar code data, as represented by block 382. For example, the fuel transaction data can be modified to reflect an amount of fuel less than actually dispensed, or a dollar value for the transaction that is discounted by the amount of the worth of the coupon.

Next, the modified fuel transaction data is transmitted from intermediary module 304 to POS controller 208 for processing as normal. Once again, the customer's use of the coupon is transparent to POS controller 208 owing to the interception of the fuel transaction data by intermediary module 304.

From the foregoing detailed description, it should be apparent to those of ordinary skill in the art that a method and apparatus for dispensing fuel additives simultaneously with the dispensation of fuel in a retail setting has been disclosed. Systems in accordance with the disclosed embodiment of the invention are advantageously adapted to be incorporated into existing retail fueling station systems, and are adapted to be operable before and during the normal fuel dispensing process.

As described above, the invention in part involves the use of computer-based electronic systems, of which many personal and industrial grades and types are available. The programming necessary to implement the functionality described herein is believed to be within the capability of any competent programmer, and may be accomplished through the use of a program storage device readable by the processor that encodes a program of instructions executable by the processor for performing the operations described above. The program storage device may take the form of, e.g., a floppy disk; a CD-ROM; a memory device (e.g., RAM, ROM, EPROM, EEPROM, etc.); and other forms of the kind well-known in the art or subsequently developed. The program of instructions may be “object code,” i.e., in binary form that is executable more-or-less directly by the computer; in “source code” that requires compilation or interpretation before execution; or in some intermediate form such as partially compiled code. The program storage device may be one that is directly readable by the processor, or it may be one that is unusable by the processor per se but that provides intermediate storage of the program of instructions. The program of instructions may be read directly from the program storage device by the processor; alternatively, the program of instructions may be temporarily or permanently stored in the program storage device and transmitted from it to the processor over one or more links, e.g., over a telephone connection (such as a modem connection or an ISDN line); over a cable-modem hookup; over the Internet; via radio- or satellite transmission; etc., possibly with other program storage devices providing intermediate storage along the way. The precise forms of the program storage device and of the encoding of instructions are immaterial here.

Although specific embodiments of the invention have been described herein in some degree of detail, this has been done merely to illustrate various features and aspects of the present invention, and is not to be construed as limiting the scope of the invention as defined by the claims which follow. Those of ordinary skill in the art will appreciate that various substitutions, alterations, and/or modifications, including but not limited to those design variations and options that have been specifically noted herein, may be made to any of the embodiments of the invention disclosed herein without departing from the spirit and scope of the claims which follow.

What is claimed is:

1. A fuel dispensing system, comprising:
a fuel dispenser for pumping fuel in response to dispenser control signals applied thereto;
a pump controller for generating said dispenser control signals, said pump controller having a communications interface adapted to receive transaction signals from said fuel dispenser and to transmit said dispenser control signals from said pump controller to said dispenser;
an intermediary module coupled to said communications interface and to said dispenser, said intermediary module adapted to intercept said transaction signals and said dispenser control signals;
a display and control module, coupled to said intermediary module;
a display, coupled to said display and control module, for displaying multimedia content;
wherein said intermediary module transmits at least one transaction signal from said fuel dispenser to said communications interface and to said display and control module.

2. A system in accordance with claim 1, wherein said intermediary module modifies at least one dispenser control signal received from said communications interface and transmits said modified dispenser control signal to said fuel dispenser.

3. A system in accordance with claim 1, wherein said intermediate module modifies at least one transaction signal from said fuel dispenser and transmits said modified transaction signal to said communications interface.

4. A system in accordance with claim 1, wherein said display and control module generates control signals to control said intermediary device to generate dispenser control signals and apply said dispenser control signals to said fuel dispenser.

5. A system in accordance with claim 1, further comprising a server, coupled to said display and control module by a communications link.

6. A system in accordance with claim 5, wherein said communications link comprises a wireless communications link.

7. A system in accordance with claim 5, wherein said server transmits multimedia content to said display and control module via said communications link.

8. A system in accordance with claim 7, wherein said multimedia content is displayed on said display.

9. A system in accordance with claim 1, further comprising a user interface, coupled to said display and control device, for allowing a user to specify that an additive is to be dispensed with fuel dispensed by said dispenser.

10. An intermediary module adapted to be coupled to a fuel dispenser, a dispenser controller, and a display and control module, said intermediary module responsive to dispenser control signals transmitted from said dispenser controller to process said control signals in accordance with programming provided by said display and control module and to transmit said processed control signals to said fuel dispenser.

11. An intermediary module in accordance with claim 10, wherein said intermediary module is responsive to transaction signals transmitted from said fuel dispenser to process said transaction signals in accordance with programming provided by said display and control module and to transmit said processed control signals to said dispenser controller.

12. An intermediary module in accordance with claim 11, wherein said intermediary module is responsive to control signals from said display and control module to generate dispenser control signals to be applied to said fuel dispenser.

13. An intermediary module in accordance with claim 12, wherein said intermediary module is responsive to control signals from said display and control module to generate transaction signals to be transmitted to said dispenser controller.
